(19) United States
(12) Patent Application Publication
(10) Pub. No.: US 2024/0127471 A1
(43) Pub. Date: Apr. 18, 2024

(54) INFORMATION PROCESSING APPARATUS, INFORMATION PROCESSING SYSTEM, INFORMATION PROCESSING METHOD, AND RECORDING MEDIUM

(71) Applicants: Toshihiro OKAMOTO, Kanagawa (JP); Shin AOKI, Tokyo (JP); Sukehiro KIMURA, Kanagawa (JP); Kenji NAGASHIMA, Kanagawa (JP); Toshiyuki IKEOH, Düsseldorf (DE); Soichiro YOKOTA, Kanagawa (JP)

(72) Inventors: Toshihiro OKAMOTO, Kanagawa (JP); Shin AOKI, Tokyo (JP); Sukehiro KIMURA, Kanagawa (JP); Kenji NAGASHIMA, Kanagawa (JP); Toshiyuki IKEOH, Düsseldorf (DE); Soichiro YOKOTA, Kanagawa (JP)

(21) Appl. No.: 18/277,581

(22) PCT Filed: Jan. 13, 2022
(86) PCT No.: PCT/IB2022/050221

§ 371 Date: Aug. 17, 2023

(30) Foreign Application Priority Data
Feb. 25, 2021 (JP) 2021-028975
Feb. 25, 2021 (JP) 2021-029222

(51) Int. Cl. G06T 7/70; G06T 7/20; G06V 20/56

(52) U.S. Cl. CPC G06T 7/70; G06T 7/20; G06V 20/56; G06T 2207/30204; G06T 2207/30252

(57) ABSTRACT

An information processing apparatus according to an embodiment of the present disclosure processes information about a position of an object moved by a mobile object, and includes an output unit configured to output the information about the position of the object. The information about the position of the object is obtained based on holding information indicating whether the object is held or not held by the mobile object and information about a position of the mobile object. The information about the position of the mobile object is obtained based on a captured image captured by an imaging device.

### TECHNICAL FIELD

Embodiments of the present disclosure relate to an information processing apparatus, an information processing system, an information processing method, and a recording medium.

### BACKGROUND ART

In the related art, information processing apparatuses are known that process the information about the positions of objects such as cargos or pallets moved by mobile objects such as forklifts.

A configuration or structure is disclosed that is provided with a processor configured to classify operating conditions of the carrying machine using a first signal transmitted from a first detector that directly detects the movement of a carrying machine and a second signal transmitted from a second detector that detects the presence or absence of an item being carried by the carrying machine(see, for example, PTL 1). With such a configuration or structure, using the information that indicates the position of the carrying machine, the information about the movement path of the carrying machine can be output for each one of the classified operating conditions.

### CITATION LIST

### Patent Literature

### [PTL 1]

Japanese Unexamined Patent Application Publication No. 2019-191709

### SUMMARY OF INVENTION

### Technical Problem

However, in the apparatuses disclosed in PTL 1, the signals that are output from a plurality of detectors are processed. Accordingly, the processing of the information about the positions of the objects may become complicated.

### Solution to Problem

An information processing apparatus according to an embodiment of the present disclosure processes information about a position of an object moved by a mobile object, and includes an output unit configured to output the information about the position of the object. The information about the position of the object is obtained based on holding information indicating whether the object is held or not held by the mobile object and information about a position of the mobile object. The information about the position of the mobile object is obtained based on a captured image captured by an imaging device.

### Advantageous Effects of Invention

According to one aspect of the present disclosure, information processing apparatuses can be provided that can easily process the information about the position of the objects that are moved by a plurality of mobile objects.

### BRIEF DESCRIPTION OF DRAWINGS

The accompanying drawings are intended to depict example embodiments of the present invention and should not be interpreted to limit the scope thereof. The accompanying drawings are not to be considered as drawn to scale unless explicitly noted. Also, identical or similar reference numerals designate identical or similar components throughout the several views.

FIG. 1 is a diagram illustrating the positions of objects in a warehouse, according to an embodiment of the present disclosure.

FIG. 2 is a schematic diagram of a configuration of an information processing system according to a first embodiment of the present disclosure.

FIG. 3 is a block diagram of a hardware configuration of an on-premises server according to an embodiment of the present disclosure.

FIG. 4 is a block diagram of a functional configuration of an information processing system according to the first embodiment of the present disclosure.

FIG. 5 is a flowchart of the processes that are performed by an on-premises server according to an embodiment of the present disclosure.

FIG. 6A, FIG. 6B, FIG. 6C are diagrams each illustrating how the image of a fork is converted, according to an embodiment of the present disclosure, where FIG. 6A is a diagram illustrating a portion of a spherical image, FIG. 6B is a diagram illustrating perspective transformation, and

FIG. 6C is a diagram illustrating a perspective transformed image.

FIG. 7A, FIG. 7B, and FIG. 7C are diagrams each illustrating a method using markers, according to an embodiment of the present disclosure, where FIG. 7A is a diagram illustrating a pair of markers, FIG. 7B is a diagram illustrating how a pair of markers are shielded by a cargo, and FIG. 7C is a diagram illustrating how the distance in the horizontal direction is estimated using a plurality of markers.

FIG. 8A and FIG. 8B are diagrams each illustrating how the height of a fork is estimated, according to an embodiment of the present disclosure, where FIG. 8A illustrates the distance between a pair of augmented reality (AR) marker images on a perspective transformed image, and FIG. 8B illustrates the relative heights of a spherical camera and a fork.

FIG. 9A and FIG. 9B are diagrams each illustrating a method of detecting a fork, according to an embodiment of the present disclosure, where FIG. 9A is a diagram illustrating a cases in which a fork is at a low position, and FIG. 9B is a diagram illustrating a cases in which a fork is at a high position.

FIG. 10A, FIG. 10B, and FIG. 10C are diagrams each illustrating the selection of a combination of edge line segments, according to an embodiment of the present disclosure, where FIG. 10A is a diagram illustrating the extraction of a straight line, FIG. 10B is a diagram illustrating a first rejection, and FIG. 10C is a diagram illustrating a second rejection according to an embodiment of the present disclosure.

FIG. 11A and FIG. 11B are diagrams each illustrating a method of determining the amount of movement of an image, according to an embodiment of the present disclosure, where FIG. 11A is a diagram illustrating a monitoring area in a perspective transformed image, and FIG. 11B is a diagram illustrating a plurality of monitoring areas in a perspective transformed image.

FIG. 12A, FIG. 12B, and FIG. 12C are diagrams each illustrating a method of determining the amount of movement of an image, according to an alternative embodiment of the present disclosure, where FIG. 12A is a diagram illustrating a monitoring area in an image, FIG. 12B is a diagram illustrating a cases in which the fork is at a low position, and FIG. 12C is a diagram illustrating a cases in which the fork is at a high position.

FIG. 13A and FIG. 13B are diagrams each illustrating a first result of obtaining the information of the positions of the objects 30, according to an embodiment of the present disclosure, where FIG. 13A illustrates a location map, and FIG. 13B is a table indicating the information about the positions of objects and time stamps.

FIG. 14A and FIG. 14B are diagrams each illustrating a second result of obtaining the information of the positions of the objects 30, according to an embodiment of the present disclosure, where FIG. 14A is a diagram illustrating divisions (A, B, C, and D), and FIG. 14B is a diagram illustrating the information about the positions of divisions (A, B, C, and D) and bar codes indicating the divisions (A, B, C, and D).

FIG. 15 is a diagram illustrating a registration screen on which an initial position of an object is registered, according to an embodiment of the present disclosure.

FIG. 16 is a diagram illustrating a registration screen 91 on which an initial position of an object is registered, according to an alternative embodiment of the present disclosure.

FIG. 17 is a diagram illustrating a display screen indicating a destination to which an object is carried by a forklift, according to an embodiment of the present disclosure.

FIG. 18 is a diagram illustrating a display screen on which a location map is displayed, where the location map indicates the locations of a plurality of objects, according to an embodiment of the present disclosure.

FIG. 19 is a diagram illustrating a display screen in which an object is being searched for, according to an embodiment of the present disclosure.

FIG. 20 is a schematic diagram of a configuration of an information processing system according to a second embodiment of the present disclosure.

FIG. 21 is a block diagram of a functional configuration of an information processing system according to a second embodiment of the present disclosure.

FIG. 22 is a diagram illustrating a forklift viewed from a fixed camera, according to an embodiment of the present disclosure.

FIG. 23 is a diagram illustrating a display screen displaying the result of tracking performed on objects by a fixed camera, according to an embodiment of the present disclosure.

FIG. 24 is a block diagram of a functional configuration of an information processing system according to a first modification of the above embodiments of the present disclosure.

FIG. 25 is a block diagram of a functional configuration of an information processing system according to a second modification of the above embodiments of the present disclosure.

### DESCRIPTION OF EMBODIMENTS

Embodiments of the present disclosure are described below with reference to the accompanying drawings. In the drawings, like reference signs denote like elements, and overlapping description may be omitted.

An information processing apparatus according to an embodiment of the present embodiment processes the information about the positions of a plurality of objects moved by a plurality of mobile objects. For example, the mobile object may be a forklift or material handling equipment, and the object includes a pallet. The information processing apparatus according to the present embodiment processes the information about the positions of a plurality of objects such as pallets moved by a plurality of forklifts to recognize and track movement of the objects.

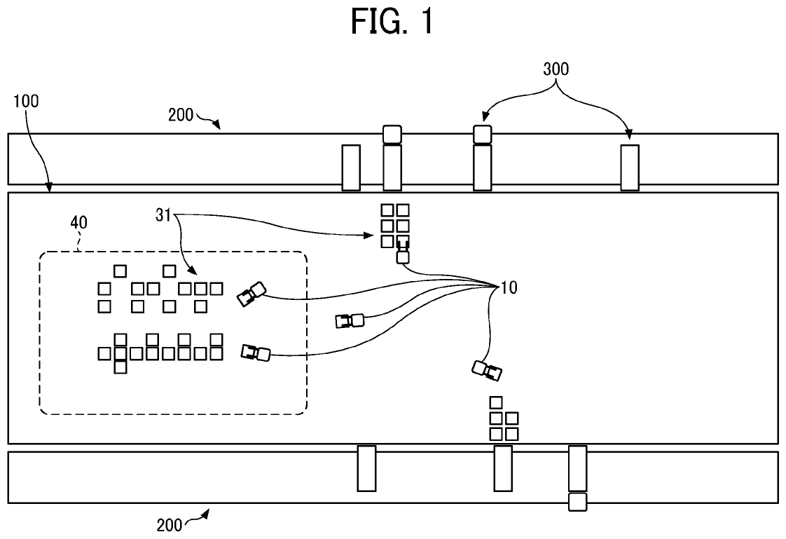

FIG. 1 is a diagram illustrating the positions of objects in a warehouse, according to an embodiment of the present disclosure.

In FIG. 1, the inside of the warehouse 100 and areas around the warehouse 100 are illustrated as viewed from the ceiling above.

The warehouse 100 according to the present embodiment is a terminal warehouse arranged at a transit point of the transportation. Such a terminal warehouse may be a warehouse of so-called cross-docking type. A plurality of pallets are shipped from, for example, a factory and a wholesaler on a product-by-product basis, and arrive at the warehouse of cross-docking type. These pallets are placed in the warehouse of cross-docking type on a temporary basis. After that, at the time of shipment, a plurality of types of pallets are combined with each other, and these pallets are shipped and directed to each retail store with no change in their outer appearance.

In FIG. 1, there are a couple of truck yards 200 around the warehouse 100. Moreover, in FIG. 1, a plurality of containers 300 are carried by trailers and detached from the trailers in the truck yard 200, and the platforms of trucks are linked to the warehouse 100. A plurality of forklifts pick up pallets 31 from at least one of the platforms of the trucks arrived at the truck yard or the containers 300 carried by trailers.

After that, the forklift 10 carries the pallet 31 to a temporary receptacle 40, and place it on a temporary basis. After that, at the time of shipment, the forklift 10 carries the pallets 31 to a place close to the truck yard 200 in the warehouse 100, aligns the pallet 31. Then, the pallets are loaded onto the platforms of trucks or the containers 300. In the temporary receptacle 40, in many cases, divisions (A, B, C, and D) are not specified on a product-by-product basis in order to allocate space on a flexible basis and to deal with variations in types and amounts of products that enter and exit on a daily basis. Moreover, as a plurality of workers place the pallets 31 at any desired places on a temporary basis, it is necessary to search for a desired pallet from a larger number of pallets at the time of shipment.

In order to efficiently perform this search operation, there is a demand for information processes systems that recognize and track the movement of the pallets 31 in the warehouse 100 to visualize the movement while effectively utilizing the space by not specifying a temporary receptacle for the pallets 31. The information processing apparatus according to the present embodiment is used in such an information processes system.

An information processing system 1 that includes the information processing apparatus according to the present embodiment is described below.

### First Embodiment

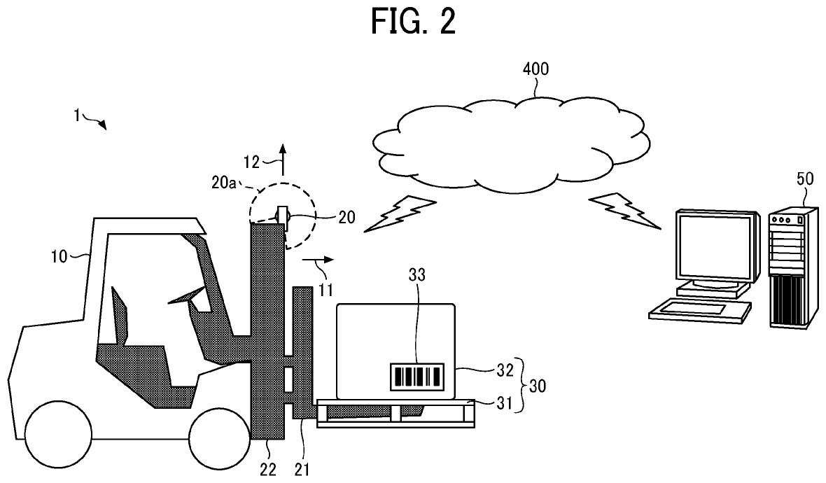

FIG. 2 is a schematic diagram of a configuration of an information processing system according to a first embodiment of the present disclosure.

As illustrated in FIG. 2, the information processing system 1 includes the multiple forklifts 10, a plurality of spherical cameras (omnidirectional cameras) 20 provided for the respective forklifts 10, and an on-premises server 50. These elements are connected to each other and can communicate with each other through a network 400 such as a local area network (LAN). Apparatuses or devices such as an external server and an image forming apparatus other than those elements described above may be connected to the network 400 such that these elements can communicate with each other.

Each of the forklifts 10 according to the present embodiment serves as a mobile object that holds a cargo 32 placed on a pallet 31 and carries the cargo 32 held by the pallet 31. The carrying operation by the mobile object is an example of the movement of the mobile object. Each one of the pallet 31 and the cargo 32 is an example of the object. When the pallet 31 and the cargo 32 are not to be distinguished from each other, they may be collectively referred to as an object 30 in the following description. The multiple forklifts 10 may collectively be referred to as the forklift 10, and the multiple pallets 31 may collectively be referred to as the pallet 31. The multiple cargos 32 may collectively be referred to as the cargo 32. The forklifts 10 according to the present embodiment may carry the objects 30 as driven or operated by an operator, or may carry the objects 30 by automatic driving without involving an operator.

The spherical camera 20 according to the present embodiment serves as an imaging device provided for the forklift 10. The spherical camera 20 is capable of capturing images in all directions of 360 degrees around the spherical camera 20. In FIG. 2, directions 20a indicate the directions in which the spherical camera 20 can capture an image.

The spherical image (omnidirectional image) that is captured by the spherical camera 20 according to the present embodiment is an example of captured image. However, the imaging device is not limited to the spherical camera 20, and may be any imaging device as long as it can capture an image of an area around the forklift 10. Further, the captured image according to the present embodiment is not necessarily be a spherical image or omnidirectional image. The spherical image includes an image in which the scenery viewed from the forklift 10 in the conveyance direction 11 of the object 30 and the scenery viewed from the forklift 10 in an upper vertical direction 12 are captured. In other words, the conveyance direction 11 is in front of the forklift 10, and the upper vertical direction 12 is above the forklift 10. As the spherical camera 20 can capture images in all directions, areas in front of or above the forklift 10 can be captured in a single image. The conveyance direction 11 according to the present embodiment is an example of moving direction.

Preferably, the spherical camera 20 is mounted on the roof of the forklift 10 or on a supporting member 22 that supports a fork 21. Due to such a configuration, the sight to capture an image of an area above or ahead of the forklift 10 can be secured as desired.

The spherical camera 20 has a wireless communication function and transmits a captured spherical image to the on-premises server 50 through the network 400.

According to the present embodiment, a bar code 33 that serves as identification data indicating the cargo 32 is arranged on the cargo 32. Such a bar code may be arranged on the pallet 31, and may be used as the identification data indicating the pallet 31. The bar code 33 is read by a reader such as a bar-code reader, and the identification data that is obtained as a result of the reading is sent to the on-premises server 50 through the network 400. The identification data is not limited to a bar code, and may be, for example, a quick response (QR) code (registered trademark) and an identifier (ID) number.

The on-premises server 50 according to the present embodiment serves as an information processing apparatus that is installed in the warehouse 100 and processes the information about the position of the objects 30 carried by the forklifts 10.

The on-premises server 50 processes the information about the position of the object 30 based on the spherical image and the identification data indicating the object 30 received through the network 400. The information about the position of the object 30 held by the forklifts 10 can be obtained using the spherical images captured by the multiple spherical cameras 20.

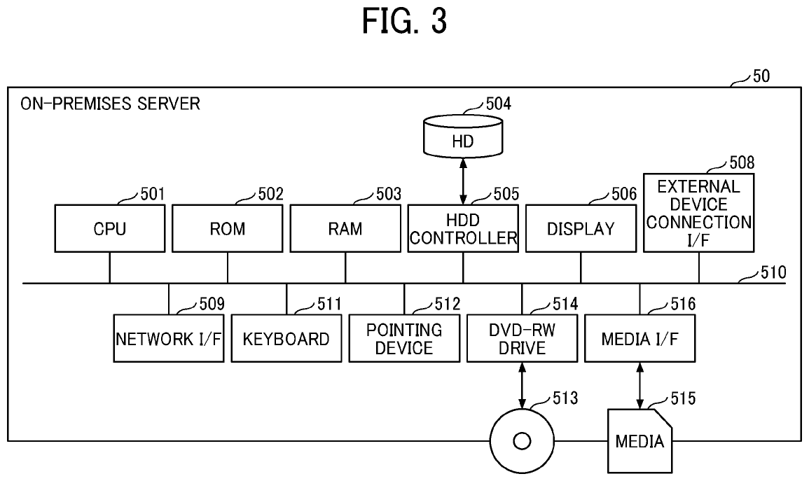

FIG. 3 is a block diagram of a hardware configuration of the on-premises server 50 according to an embodiment of the present disclosure.

The on-premises server 50 is configured by a computer or one or more processors.

As illustrated in FIG. 3, the on-premises server 50 includes a central processing unit (CPU) 501, a read only memory (ROM) 502, a random access memory (RAM) 503, a hard disk (HD) 504, a hard disk drive (HDD) controller 505, and a display 506. Moreover, the on-premises server includes an external device connection interface (I/F) 508, a network interface (I/F) 509, a bus line 510, a keyboard 511, a pointing device 512, a digital versatile disk rewritable (DVD-RW) drive 514, and a medium interface (I/F) 516.

Among these elements, the CPU 501 controls the overall operation of the on-premises server 50. The ROM 502 according to the present embodiment stores a control program such as an initial program loader (IPL) used to drive the CPU 501. The RAM 503 according to the present embodiment is used as a work area for the CPU 501.

The HD 504 according to the present embodiment stores various kinds of data such as a program. The HDD controller 505 controls reading or writing of various kinds of data to or from the HD under the control of the CPU 501. The display 506 displays various kinds of information such as a cursor, menu, window, characters, or image.

The external device connection interface 508 is an interface circuit that connects the above devices or systems to various kinds of external devices. The external devices in the present embodiment may be, for example, a universal serial bus (USB) memory and a printer. The network interface 509 controls data communication with an external device through the network 400. The bus line 510 is, for example, an address bus or a data bus, which electrically connects various elements such as the CPU 501 illustrated in FIG. 3.

The keyboard 511 is one example of input device provided with a plurality of keys used to input, for example, characters, numerical values, and various kinds of instructions. The pointing device 512 is one example of input device for selecting or executing various kinds of instructions, selecting an object to be processed, or for moving a cursor. The DVD-RW drive reads or writes various types of data on a digital versatile disk rewritable (DVD-RW) 513, which is one example of removable recording medium to be controlled. The DVD-RW may be, for example, a DVD-R. The medium interface 516 controls reading or writing of data to or from a recording medium 515 such as a flash memory.

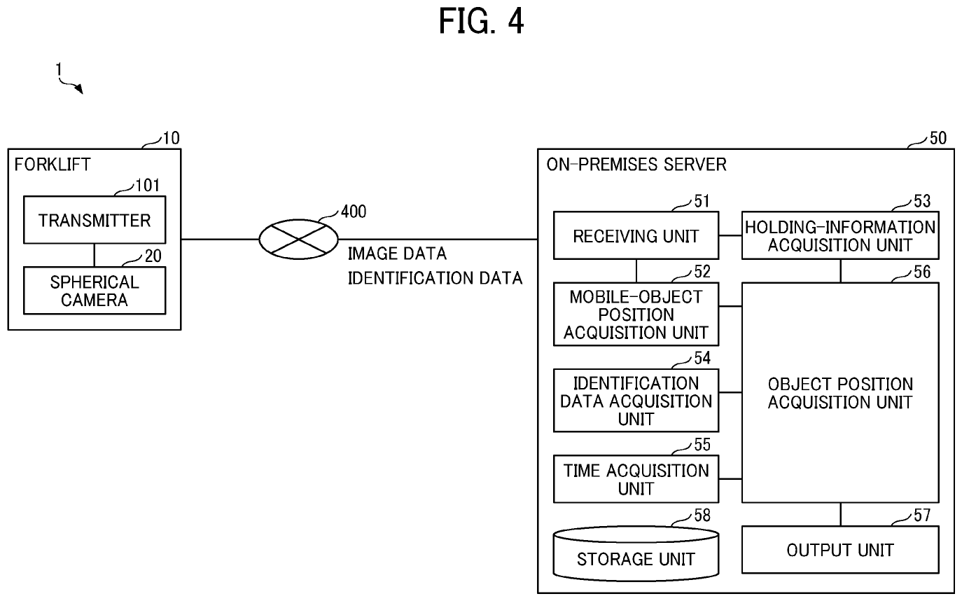

FIG. 4 is a schematic diagram of a functional configuration of the information processing system 1 according to the first embodiment of the present disclosure.

As illustrated in FIG. 4, the on-premises server 50 includes a receiver 51, a mobile-object position acquisition unit 52, a holding-information acquisition unit 53, an identification data acquisition unit 54, a time acquisition unit 55, an object position acquisition unit 56, an output unit 57, and a storage unit 58.

These units are functions implemented by or caused to function by operating some of the elements illustrated in FIG. 3 under the control of the instructions from the CPU 501. Note also that such instructions from the CPU 501 are made in accordance with the program expanded from the HD 504 to the RAM 503.

The forklift 10 is provided with the spherical camera 20 and a transmitter 101. The functions of the transmitter 101 may be implemented by an electric circuit provided for one of the forklift and the spherical camera 20, or may be implemented by software executed by a central processing unit (CPU). Alternatively, the functions of the transmitter 101 may be implemented by a plurality of electric circuits or a plurality of software components.

The on-premises server 50 according to the present embodiment obtains the information about the positions of the objects 30, which are obtained based on the information about the positions of the forklifts 10, which is obtained based on the spherical images captured by the spherical camera 20, and the holding information indicating whether each one of the objects 30 is held or not held by any one of the forklifts 10. The obtained the information about the position of the object 30 can be output to an external device through the output unit 57.

The receiver 51 receives the spherical image captured by the spherical camera 20 and transmitted through the transmitter 101 through the network 400, and outputs the spherical image to each of the mobile-object position acquisition unit 52 and the holding-information acquisition unit 53. The receiver 51 receives identification data read by a reader such as a bar code reader through the network 400, and outputs the identification data to the identification data acquisition unit 54.

The mobile-object position acquisition unit 52 according to the present embodiment computes and obtains the information of the positions of the forklifts 10 based on the input spherical image, and outputs the information about the position of the forklifts 10 to the object position acquisition unit 56. For example, simultaneous localization and mapping (SLAM) may be applied to the processes of obtaining the information about the positions of the forklifts 10, which may be referred to as localization in the following description (see, for example, “Tomono, M., & Hara, Y. (2020). Commentary on Current Status and Future Prospects of SLAM. System/Control/Information, vol. 64, No. 2, pp. 45-50, from https://www.jstage.jst.go.jp/article/isciesci/64/2/64_45/_article/-char/jar).

The holding-information acquisition unit 53 according to the present embodiment computes and obtains the holding information indicating whether the objects 30 are held or not held by the forklifts 10, based on the input spherical image, and outputs the holding information to the object position acquisition unit 56.

The identification data acquisition unit 54 according to the present embodiment obtains the identification data due to the input through the receiver 51, and outputs the identification data to the object position acquisition unit 56. However, the acquisition of the identification data by the identification data acquisition unit 54 is not limited to the acquisition through the network 400. For example, the identification data acquisition unit 54 according to the present embodiment may obtain the identification data input by a user such as an administrator, using the keyboard 511 or the pointing device 512 as illustrated in FIG. 3, or may obtain the identification data stored in advance in the storage unit 58. Alternatively, the identification data acquisition unit 54 according to the present embodiment may obtain the identification data through the external device connection interface 508. The term administrator used in the present embodiment is an administrator of, for example, the information processes system 1 and the warehouse 100.

The time acquisition unit 55 according to the present embodiment obtains the data indicating the time at which the receiver 51 received the spherical image and the identification data, and outputs the data indicating the time to the object position acquisition unit 56.

The object position acquisition unit 56 according to the present embodiment obtains the information of the positions of the objects 30 based on the information about the position of the forklifts 10 and the holding information of the objects 30. Then, the object position acquisition unit 56 associates the information about the position of the object 30, the data identifying the object 30, and the information about time with each other, and outputs the associated data through the output unit 57. The destination to which the output unit 57 according to the present embodiment outputs data is, for example, an external device such as a personal computer (PC), a display device such as the display 506, and a storage device such as the HD 504.

The storage unit 58 can store the data identifying the objects 30 such as the pallets 31 and the cargo 32.

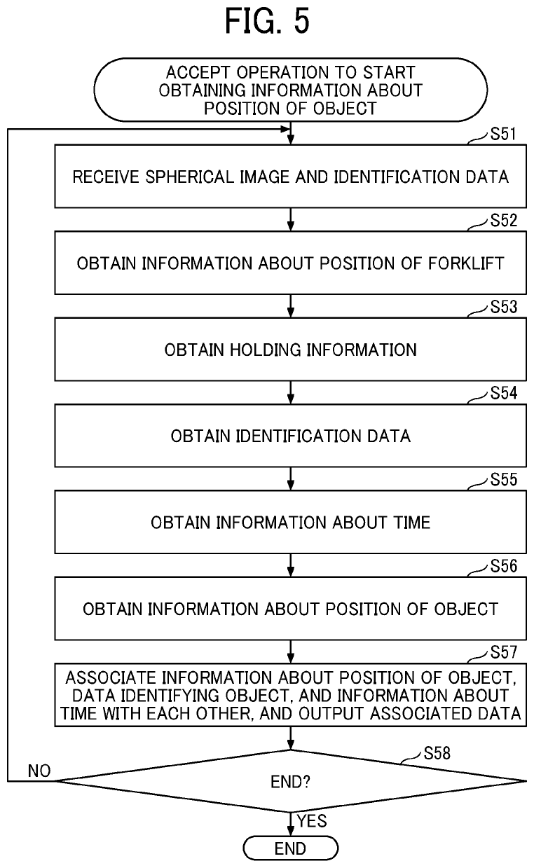

FIG. 5 is a flowchart of the processes performed by the on-premises server 50 according to the first embodiment of the present disclosure.

FIG. 5 illustrates a series of processes triggered by the acceptance of an operation to start obtaining the information of the positions of the objects 30 by the on-premises server 50. The operation to start obtaining the information about the positions of the objects 30 is performed by a user such as an administrator, using, for example, the pointing device 512 as illustrated in FIG. 3.

Firstly, in a step S51, the receiver 51 receives the spherical image and the identification data through the network 400.

Subsequently, in a step S52, the mobile-object position acquisition unit 52 computes and obtains the information of the positions of the forklifts 10 based on the input spherical image, and outputs the information about the position of the forklifts 10 to the object position acquisition unit 56.

Subsequently, in a step S53, the holding-information acquisition unit 53 computes and obtains the holding information indicating whether the objects 30 are held or not held by the forklifts 10, based on the input spherical image, and outputs the holding information to the object position acquisition unit 56.

Subsequently, in a step S54, the identification data acquisition unit 54 obtains the identification data identifying the object 30 due to the above input, and outputs the identification data to the object position acquisition unit 56.

Subsequently, in a step S55, the time acquisition unit 55 obtains the data indicating the time at which the receiver 51 received the spherical image and the identification data, and outputs the data indicating the time to the object position acquisition unit 56. The processes in the steps S52 to S55 may be performed in any desired different order, may be performed in parallel.

Subsequently, in a step S56, the object position acquisition unit 56 obtains the information of the positions of the objects 30 based on the information about the position of the forklifts 10 and the holding information of the objects 30.

Subsequently, in a step S57, the object position acquisition unit 56 according to the present embodiment associates the information about the positions of the objects 30, the identification data indicating the objects 30, and the time data with each other, and outputs the obtained information through the output unit 57.

Subsequently, in a step S58, the on-premises server 50 according to the present embodiment determines whether to the processes are to be terminated. The on-premises server 50 according to the present embodiment determines whether the processes are to be terminated, based on an operation made by a user such as an administrator to the processes through, for example, the pointing device 512.

When it is determined that the processes are to be terminated in the step S58 (“YES” in the step S58), the on-premises server 50 terminates the processes. On the other hand, when it is determined that the processes are not to be terminated (“NO” in the step S58), the on-premises server 50 repeats the processes in the step S51 and the following steps.

As described above, the on-premises server 50 can process the information about the positions of the objects 30 to obtain the information about the positions of the objects 30.

A method of obtaining holding information by the holding-information acquisition unit 53 is described below in detail.

In the present embodiment, the holding-information acquisition unit 53 obtains the holding information of the objects 30 held by the forklift 10 and the information about the absolute positions of the objects 30 at the time of attachment and detachment. In other words, the holding information of the object 30 is the information about the attachment and detachment timing indicating loading and unloading of the object 30. The holding-information acquisition unit 53 according to the present embodiment obtains the information about the attachment and detachment timing of the objects 30 based on the spherical images captured by the spherical camera 20.

A close-proximity sensor that uses, for example, infrared rays and ultrasonic waves may be used to obtain the information about the attachment and detachment timing of the objects 30. Sensors such as a load sensor that detects the load of the cargo 32 and a height sensor for a fork that are built in the forklift 10 or externally attached to the forklift 10 may be used.

As illustrated in FIG. 2, the spherical camera 20 that is attached to the fork 21 can capture, for example, the fork 21 and the object 30 in a single spherical image.

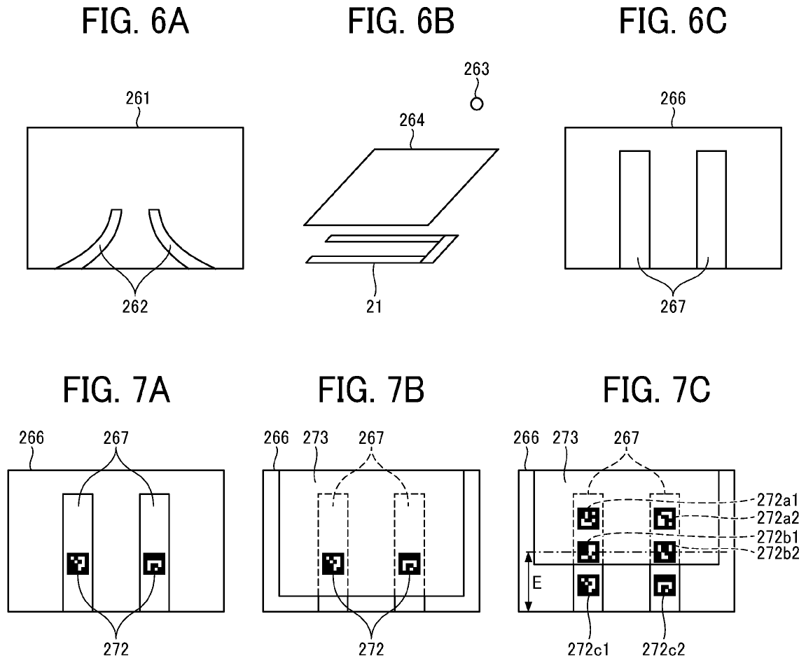

FIG. 6A, FIG. 6B, FIG. 6C are diagrams each illustrating how the image of the fork 21 is converted, according to an embodiment of the present disclosure.

More specifically, FIG. 6A illustrates a portion of a spherical image, and FIG. 6B illustrates perspective transformation. FIG. 6C illustrates a perspective transformed image.

The spherical camera 20 projects a wide-angle sight onto a plane using a projection system or method such as equirectangular projection or equidistant projection. However, in such a projection system or method, a straight line in a three-dimensional space is projected like a curve as in a fork image 262 as illustrated in FIG. 6A. For this reason, the fork 21 most of which is constituted by straight portions are projected as curves, and such projection of straight portions as curves is not desirable for the acquisition processes of the information about the attachment and detachment timing. Accordingly, in the present embodiment, an image that is obtained by transforming only an capturing range including, for example, the fork 21 and the object 30 in the spherical image 261 into a perspective transformation image in advance is used. Due to such configurations as described above, image recognition that makes use of general-purpose algorithms such as straight-line detection can be achieved.

As illustrated in FIG. 6B, an appropriate range that is parallel to the floor and includes the entirety of the fork 21 is set as an to-be-captured plane 264 of the virtual perspective transformed image. The entirety of the fork is included by aligning the vertical axis with the longer-side direction of the fork 21. The center of the projection by the spherical camera 20 may be referred to as a projection center 263 in the following description.

As a result, a fork image 267 in which two bars of the fork 21 are arranged approximately parallel to each other can be obtained as in a perspective transformed image 266 as illustrated in FIG. 6C. This transformation can be implemented based on the original projection system of the spherical image 261 and the installation direction of the spherical camera 20.

Accordingly, the installation direction of the spherical camera 20 may be measured when the spherical camera 20 is attached to the forklift 10. The processes of obtaining the information about the attachment and detachment timing of the object 30, using the perspective transformed image 266 as an input image are described below.

An additional camera may be arranged in addition to the spherical camera 20, and the information about the attachment and detachment timing may be obtained using such an additional camera. However, even in such cases, it is difficult to install the camera directly above the center of the fork 21. For this reason, the perspective transformation processes are considered to be effective.

Preferably, a marker such as a bar code and an AR marker is arranged in advance on the surface of the fork 21 whose image is to be captured by the spherical camera (omnidirectional camera) such that an image can easily be recognized. For example, the image recognition function of the AR marker of the open-source software OpenCV (Open Source Computer Vision Library) may be used for the image recognition processes of the AR marker.

FIG. 7A, FIG. 7B, and FIG. 7C are diagrams each illustrating a method using markers, according to the present embodiment. In such a method, the holding information is obtained using a plurality of AR markers.

More specifically, FIG. 7A is a diagram illustrating a pair of markers, and FIG. 7B illustrates how a pair of markers are shielded by the cargo 32, according to the present embodiment. Moreover, FIG. 7C illustrates how the distance in the horizontal direction is estimated using a plurality of markers, according to the present embodiment.

A plurality of AR marker images 272 as illustrated in FIG. 7A, FIG. 7B, and FIG. 7C indicate the images of a plurality of AR markers arranged on the fork 21. The AR marker according to the present embodiment serves as an identification marker. Based on the multiple AR marker images 272, the information about the positions of the AR markers and the identification data indicated by the AR markers can be obtained at high speed.

When the forklift 10 does not hold the object 30, as illustrated in FIG. 7A, an augmented reality (AR) marker image 272 is detected on the perspective transformed image 266. By contrast, when the forklift 10 holds the object 30, as illustrated in FIG. 7B, the multiple AR marker images 272 are blocked by the object 30 and are not detected on the perspective transformed image 266.

In the present embodiment, the above is made use of, and the information about the attachment and detachment timing of the object 30 is obtained from the result of the detection performed on the perspective transformed image 266 to detect the multiple AR marker images 272. In FIG. 7B, the fork image 267 is illustrated as seeing through the cargo image 273, but the AR marker cannot be seen at all and cannot be detected on the perspective transformed image 266 as shielded by the cargo image 273.

The holding-information acquisition unit 53 according to the present embodiment obtains the information about the attachment and detachment timing at which the state changes from a state in which the multiple AR marker images 272 cannot be detected to a state in which the multiple AR marker images 272 can be detected on the perspective transformed image 266, as a time at which the pallet is loaded. By contrast, the holding-information acquisition unit 53 according to the present embodiment obtains the information about the attachment and detachment timing at which the state changes from the state in which the multiple AR marker images 272 can be detected to the state in which the multiple AR marker images 272 cannot be detected on the perspective transformed image 266, as a time at which the pallet is unloaded. However, there is an error in the above obtaining processes. For this reason, it is desired that noise reduction processes be performed. For example, the result of obtaining processes may be adopted only when a plurality of frames are detected on a continuous basis. Such an error in obtaining processes is, for example, an error caused as the multiple AR marker images 272 are not detected despite the fact that the multiple AR marker images 272 are included in the perspective transformed image 266, and an error caused as the multiple AR marker images 272 are detected despite the fact that the AR marker images 272 are not included in the perspective transformed image 266.

How the holding-information acquisition unit 53 according to the present embodiment determines the positions of the objects 30 to be attached or detached based on the results of the visual simultaneous localization and mapping (SLAM) performed to obtain the information of the positions of the forklifts 10 and the perspective transformed image 266 from which the information about the attachment and detachment timing is obtained is described below.

When the installed position of the spherical camera 20 on the forklift 10 is consistent and the size of the object 30 to be held is substantially constant, the relative positions of the spherical camera 20 and the object 30 in the horizontal direction are considered to be substantially constant. For example, it is assumed that the forklift 10 holds the object 30 such that the center of the pallet 31 is located at a distance of about 1 meter (m) from the spherical camera 20 in the conveyance direction 11 of the forklift 10.

The conveyance direction 11 of the forklift 10 can be measured by the visual SLAM. The holding-information acquisition unit 53 can determine, as the absolute positions of the objects at the time of attachment and detachment, a position that is, for example, 1 meter (m) away from the absolute positions of the spherical cameras 20 at the time of attachment and detachment of the objects 30 in the conveyance directions 11 of the forklifts 10.

If a plurality of AR markers having different identification data are disposed on the surface of the fork 21 and the object 30 is held at the front ends of the fork 21 depending on which one of the AR markers is detected on the perspective transformed image 266, it is possible to deal with cases in which the distance between the spherical camera 20 and the object 30 in the horizontal direction changes.

For example, three AR markers are disposed each one of the two bars of the fork 21. AR marker images 272a1, 272b1, and 272c1 and AR marker images 272a2, 272b2, and 272c2 as illustrated in FIG. 7C are images of a plurality of AR markers on the perspective transformed image 266.

In the present embodiment, it is assumed that the AR marker images 272c1 and 272c2 are detected on the perspective transformed image 266, and that the AR marker images 272a1, 272a2, 272b1, and 272b2 are not detected on the perspective transformed image 266. In such a case, it is determined that the object 30 is held at a position away from the base of the fork 21 by distance E. As a result, the distance between the spherical camera 20 and the object 30 in the horizontal direction can be determined to be 1+E meter (m) that is longer than the distance when the object reaches the base of the fork 21, which is, for example, 1 m, by the distance E.

Typically, the forklift 10 can move the fork 21 up and down in the vertical direction, and picks up the cargo 32 placed on the floor. Moreover, for example, the forklift 10 can load only the pallet 31 placed on another cargo 32, or can place the pallet 31 on another cargo 32 in the reversed manner. The holding-information acquisition unit 53 obtains the information about the positions of the objects 30 in the height direction at the time of such attachment and detachment as above, based on the spherical image.

In the perspective transformed image 266, the size within the perspective transformed image changes in inverse proportion to the distance from the spherical camera 20 to the object 30. Accordingly, the holding-information acquisition unit 53 can estimate the distance to the object based on the size of the object 30 in the perspective transformed image 266, the actual size of the object 30, and the focal length of the lens included in the spherical camera 20.

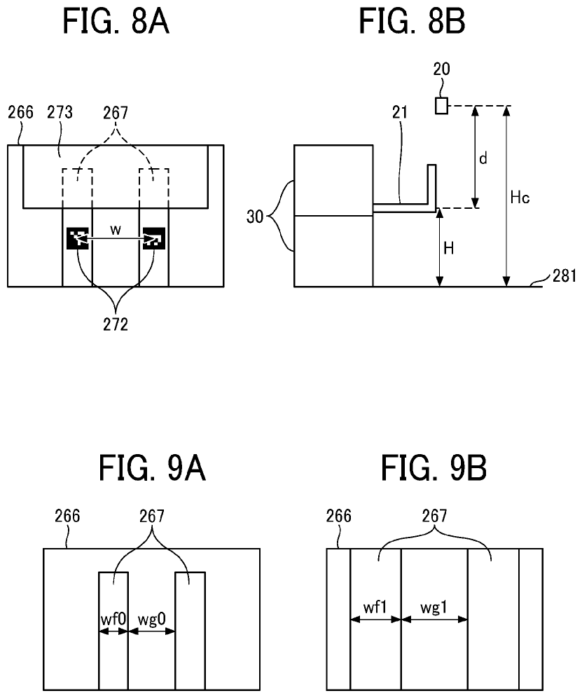

FIG. 8A and FIG. 8B are diagrams each illustrating how the height the fork 21 is estimated, according to the present embodiment.

More specifically, FIG. 8A illustrates the distance between the pair of AR marker images 272 on the perspective transformed image 266, and FIG. 8B illustrates the relative heights of the spherical camera 20 and the fork 21.

As illustrated in FIG. 8A, the distance w between the two bars in the fork image 267 on the perspective transformed image 266 is measured based on the positions of the multiple AR marker images 272 arranged on the two bars in the fork image 267 detected on the perspective transformed image 266.

While the forklift 10 is holding the object 30, the multiple AR marker images 272 cannot be detected. However, the height of the fork 21 is while the object 30 is being attached or detached by the forklift 10. Accordingly, as illustrated in FIG. 8B, a distance d in the height direction between the spherical camera 20 and the AR marker, that is, between the spherical camera 20 and the fork 21 when the object 30 is attached or detached can be measured from an interval w between the AR marker images 272 on the fork 21 immediately before the loading time or immediately after the unloading time.

Regarding the perspective transformed image 266, a first equation as given below holds true. In the first equation, S denotes the size of the object 30 on a plane parallel to the to-be-captured plane 264, and s denotes the size of the object 30 on the perspective transformed image 266. Moreover, d denotes the distance between the spherical camera 20 and the object 30, and f denotes the focal length of a lens included in the spherical camera 20.

D=S×f/s

If the actual length of spacing W between the pair of AR markers on the fork 21 is measured in advance, the distance d between the spherical camera 20 and the object 30 can be obtained based on the length of spacing w between the pair of AR marker images 272 on the perspective transformed image 266. In other words, the distance d can be computed and obtained by substituting W and w for S and s, respectively, in the first equation.

If the height He of the position where the spherical camera 20 is attached from the floor 281 is measured in advance, the height H of the fork 21 from the floor 281 can be calculated by the second equation given below.

H=Hc−d

When the spherical camera 20 is attached to a portion of the forklift 10 that moves in the vertical up-and-down directions, the height He of the spherical camera 20 can be determined based on the result of the processes of the visual SLAM.

As the top surface of the fork 21 contacts the pallet 31 and friction occurs in an intense manner, the arranged AR markers may be damaged or contaminated. In order to handle such a situation, the holding-information acquisition unit 53 according to the present embodiment can obtain the information about the attachment and detachment timing using a fork detection method in which no AR marker is used.

In the fork detection method, the fork image 267 is detected from the perspective transformed image 266. The fork 21 moves up and down in the vertical direction, and its position changes. Although the position and size of the fork changes on the perspective transformed image 266 as the distance from the spherical camera 20 changes while the thickness and the space between the two bars on the fork image 267 are constant, such changes are deformation that occurs in parallel.

Accordingly, the ratio between the thickness wf and interval wg of the fork image 267 does not change.

FIG. 9A and FIG. 9B are diagrams each illustrating a method of detecting a fork, according to the present embodiment.

More specifically, FIG. 9A illustrates a case in which two bars of the fork 21 are at a low position, and FIG. 9B illustrates a case in which the two bars of the fork 21 are at a high position according to the present embodiment. In FIG. 9A and FIG. 9B, the ratio of the thickness wf and interval wg of the fork image 267 does not change. Accordingly, the following equation is obtained.

wf0/wg0=wf1/wg1

Focusing on this ratio, the outline of the fork image 267 is detected. It is assumed that the two bars of the fork 21 have the same thickness.

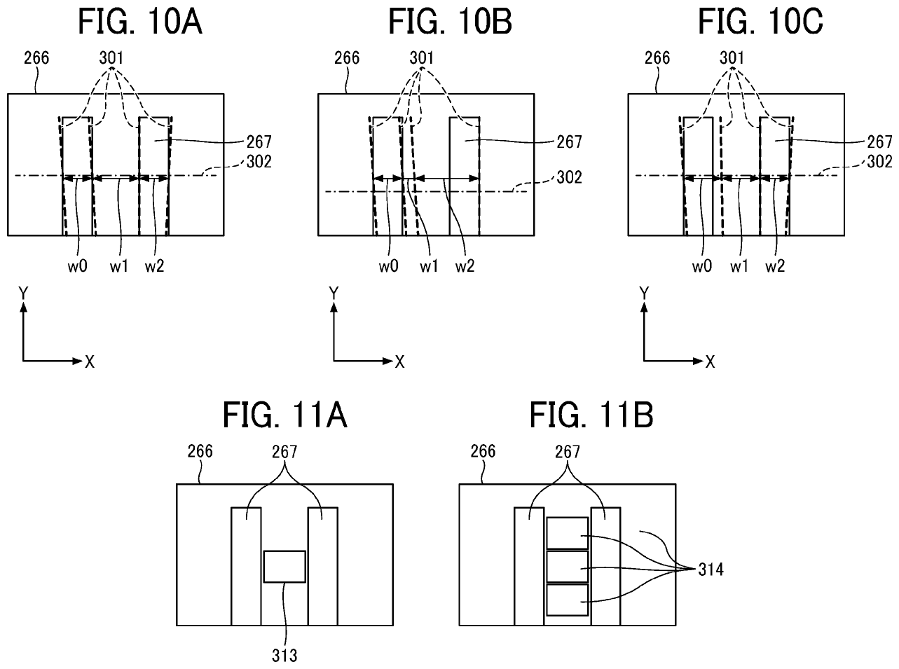

FIG. 10A, FIG. 10B, and FIG. 10C are diagrams each illustrating selection of a combination of edge line segments, according to the present embodiment.

More specifically, FIG. 10A illustrates extraction of a straight line according to the present embodiment, and FIG. 10B illustrates a first rejection according to the present embodiment. FIG. 10C illustrates a second rejection according to the present embodiment.

Firstly, a straight line segment is detected from an input image using, for example, a Canny filter and Hough transform.

Subsequently, among the detected straight line segments, only straight line segments whose directions are close to the Y-direction are extracted. Under such conditions, there is a high probability that a straight line segment other than the outline of the fork image 267 due to, for example, dirt on the fork 21 and a floor line is included. In order to handle such a situation, the straight line segment is selected as in the procedure given below.

Subsequently, straight lines 301 that are any desired four lines are selected from the detected straight lines in the Y-direction, and three items of spacing w0, w1, and w2 between each pair of the four straight lines are measured. The spacing w0 and w2 at both ends correspond to the thickness of the two bars of the fork 21, and the spacing w1 in the center corresponds to the spacing between the two bars of the fork 21. Note also that the four straight lines 301 may collectively be referred to as the straight line 301.

The detected straight lines 301 are not parallel lines in a strict sense due to an inclination of the fork image 267 or a detection error, but are lines substantially parallel to the Y-direction. Accordingly, as illustrated in FIG. 10A, the spacing between a pair of points of intersection with a predetermined horizontal line 302 in the X-direction can be regarded as a width.

Subsequently, among the combinations of edges having thickness and spacing of the fork image on the perspective transformed image 266 within the range of movement of the fork 21 measured in advance, a combination of four edges that has a ratio closest to an actually-measured value are adopted as fork edges.

For example, as illustrated in FIG. 10B, when the captured image of the fork 21 in the movement range of the fork 21 is too thick or when the spacing is too narrow, a combination of four edges is rejected. In FIG. 10C, the ratio of the thickness and the spacing is far from the ratio of the actual size compared with FIG. 10A. As a result, a combination of four edges in FIG. 10A is selected.

As described above, as the fork image 267 is detected focusing on the edge, stable detection can be performed without being affected by changes in the appearance due to illumination conditions or dirt on the surface of the fork 21. Without arranging an AR marker on the fork 21, the position of the fork 21 that moves in the vertical up-and-down directions on the perspective transformed image 266 can be determined. As a result, the information about the attachment and detachment timing of the objects 30 can be obtained in a similar manner to the above method using AR markers.

More specifically, in the perspective transformed image 266, whether the fork image 267 is detected serves as an alternative to whether the multiple AR marker images 272 is detected, and the interval between the pair of fork images 267 on the perspective transformed image 266 serves as an alternative to the distance between the AR marker images 272 on the perspective transformed image 266. Due to such a configuration, the information about the attachment and detachment timing and the attachment and detachment position of the object 30 can be determined.

The horizontal distance between the spherical camera 20 and the object 30 can also be measured by using the vertical length of the edge of the detected fork image 267 as a substitute for the detection result of the plurality of AR marker images 272.

Edge-based detection of the fork 21 works well on flat floors. However, when a vertical line having a shape similar to that of the fork 21 is present on the surface of the cargo 32 or the pallet 31, erroneous recognition may occur. As a detection method that does not depend on the external appearance of the cargo 32, a method of determining the amount of movement of an image described below may be used.

When the cargo 32 is not held and the fork 21 is viewed from above in the vertical direction, the floor is seen through the space between the two bars of the fork 21. On the other hand, when the cargo 32 is held, the floor cannot be seen regardless of the external appearance unless the cargo 32 and the pallet 31 is transparent.

When the forklift 10 is not holding the cargo 32,
the position of the patterns on the floor change on the perspective transformed image 266 due to the movement of the forklift 10. However, if the image of the cargo 32 held by the forklift is included in the perspective transformed image 266, the position in the perspective transformed image 266 does not change significantly even if the forklift 10 moves.

In view of these circumstances, in the method of determining the amount of movement of an image, an area where the floor is supposed to be viewable is monitored when the cargo 32 is not held on the perspective transformed image 266, and the holding information of the object is obtained based on information indicating whether temporal changes correspond to the movement of the forklift 10.

FIG. 11A and FIG. 11B are diagrams each illustrating a method of determining the amount of movement of an image, according to the present embodiment.

More specifically, FIG. 11A illustrates a monitoring area 313 in the perspective transformed image 266, and FIG. 11B illustrates a plurality of monitoring areas 314 in the perspective transformed image 266.

Firstly, a monitoring area 313 is set between the pair of fork images 267 on the perspective transformed image 266 (see FIG. 11A). When the cargo 32 is not held, an image of a subject such as a floor other than the fork 21 is included in the monitoring area 313. By contrast, when the cargo 32 is held, an image of the cargo 32 is included in the monitoring area 313. If the monitoring area 313 is too small, the amount of feature that is included in the image of a monitoring area tends to be small. Accordingly, tracking becomes difficult. On the other hand, if the monitoring area 313 is too large, both the floor and the cargo 32 is included in the image of a monitoring area, and distinction becomes difficult. In the method according to the present embodiment, the monitoring area 313 is a square or rectangle whose at least one side is included in the spacing between the two bars of the fork 21. If the shape of the interval between the fork 21 is long and narrow, as illustrated in FIG. 11B, a plurality of monitoring areas 314 may be arranged, and comprehensive determination may be made based on the results of tracking performed independently for each one of the monitoring areas 314.

A description will be given of a case where the position of the forklift 10 is changed by a certain distance from the previous image frame as a result of acquiring the information about the positions of the forklift 10 using the visual SLAM.

Firstly, whether or not there is a traceable feature point in the monitoring area 313 is determined. For example, a Harris operator can be used.

If there is a feature point, the amount of displacement in the image is measured with reference to the previous image frame. For example, template matching technologies may be used for the measurement.

Subsequently, the amount of displacement on the image when the feature point is fixed onto the floor is predicted based on the information about the relative positions of the previous image frame and the current image frame.

The amount of displacement in the result of tracking is predicted from the amount of self-movement, and determination is made as to whether the amount of displacement in the result of tracking is close to the amount of movement on the image or close to an amount as if no movement is made. Even when the object 30 is held by the forklift 10, the object 30 may be slightly displaced due to, for example, vibration and shaking. If the feature point is at a position higher than the floor and close to the camera, the object 30 moves more than the expected amount of movement on the floor. In order to handle such a situation, for example, when there is a displacement equal to or greater than a half of the movement of an image in the direction parallel to the direction in which the image is moved due to the changes in the position of itself, a feature point is determined to be fixed to the floor. When the displacement is equal to or less than a predetermined amount in any direction and there is a displacement equal to or greater than a half of the movement of an image in the direction parallel to the direction in which the image is moved due to the changes in the position of itself, a feature point can be determined to be a fixed feature point by the spherical camera 20. Otherwise, a feature point is considered to be a mismatch, and is rejected.

As described above, it can be determined that the object 30 is not held when it is determined that the image between the two bars of the fork 21 is fixed to the floor, and it can be determined that the object 30 is held when it is determined that the spherical camera 20 is in a fixed state.

When the floor is flat and has poor changes in brightness, no feature is detected. Accordingly, the degree of displacement cannot be measured. However, during a period of time in which the fork 21 is inserted into or pulled out from the pallet 31, there is a high probability that an edge of the pallet 31 serves as a feature point and an image can be tracked. Accordingly, before and after the timing at which the object 30 is loaded, a change from the detection of a feature point fixed to the floor to the detection of a fixed feature point fixed to the spherical camera 20 is likely to occur. By contrast, before and after the timing at which the object 30 is unloaded, a change from the detection of a fixed feature point fixed to the spherical camera 20 to the detection of a feature point fixed to the floor is likely to occur. Accordingly, such a period of time therebetween can be determined to be the attachment and detachment timing.

For the safety reasons, in many cases, the forklift 10 stops or moves at an extremely low speed when the object 30 is attached or detached. In view of these circumstances, the point in time at which the moving speed of the forklift 10 is minimized around the timings at which changes occur is considered to be the attachment and detachment timing. By so doing, the accuracy or precision can further be improved.

It is difficult to measure the height of the object 30 at the time of attachment and detachment based only on the determination using the amount of movement of an image. In order to handle such a situation, the height is detected upon detecting fork edges before and after the attachment and detachment timing.

When the spherical camera 20 is fixed above the base of the fork 21 in the vertical direction and the fork 21 moves only up and down, the monitoring area 313 that is used to determine the amount of movement can be fixed on the perspective transformed image 266. However, it may be better to change the monitoring area 313 depending on the state of the fork 21.

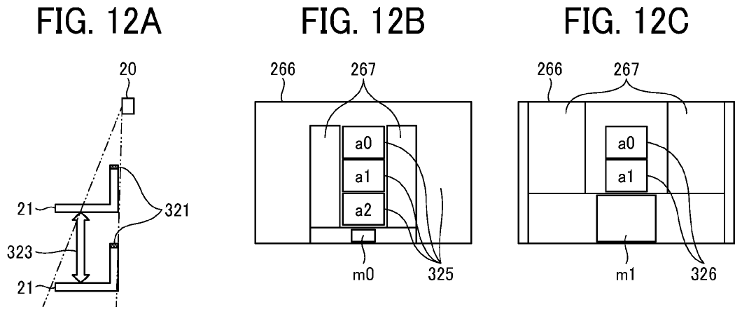

FIG. 12A, FIG. 12B, and FIG. 12C are diagrams each illustrating a method of determining the amount of movement of an image, according to an alternative embodiment of the present disclosure.

FIG. 12A is a diagram illustrating a monitoring area in an image, according to the present embodiment. FIG. 12B illustrates a cases in which the fork 21 is at a low position according to the present embodiment. FIG. 12C illustrates a cases in which the fork 21 is at a high position according to the present embodiment.

For example, when the spherical camera 20 is attached to the supporting member 22, as illustrated in FIG. 12A, the fixation member 321 at the base of the fork 21 may be interposed between the spherical camera 20 and the fork 21 and included in the perspective transformed image 266 depending on the position of the fork 21 in the vertical direction. As the fixation member 321 moves together with the forklift 10, even when the object 30 is not held, the fixed feature point of the spherical camera 20 may be detected. Such detection of the fixed feature point may lead to erroneous recognition.

Also when, for example, the spherical camera 20 is fixed to a position that is not affected by the forward and backward inclination of the supporting member 22, the position of the fork image 267 moves up and down in the vertical direction. As a result, the monitoring area also moves accordingly in an unintentional manner. In order to deal with these cases, an AR marker can be installed on a member that interlocks with the monitoring area, and the position and size of the monitoring area can be changed according to the detection position of the AR marker.

For example, as illustrated in FIG. 12B, when an AR marker is detected on an obstacle at a position m0, three areas a0, a1, and a2 are set as monitoring areas. When an AR marker is detected at a position m1 as illustrated in FIG. 12C, the area a2 is excluded from the monitoring area, and only the areas a0 and a1 are monitored. Moreover, cases in which the fork 21 moves and the monitoring area shifts can be handled in a similar manner to the above.

In these cases, since the possibility of wear of the AR marker is low compared to the surface of the fork 21, it is considered that long-term operation is also possible. If the shape of a member to be detected is known and stable, the shape of the member can be detected without an AR marker in a similar manner to the fork detection method.

In the method of determining the amount of movement of an image, it is assumed that the spherical camera 20 is disposed at a position from which the floor can be seen through the spacing between the pair of bars of the fork 21. Depending on the installation position of the spherical camera 20, the fork 21 itself may be shielded by an obstacle and may be not included in the spherical image captured by the spherical camera 20. For example, when the spherical camera 20 is attached to the supporting member 22 and the object 30 having a certain height is held, it is likely that the object 30 is included in the spherical image. However, the fork 21 may be not included in the spherical image.

In such cases, when the object 30 is not held, a wall or the like existing in the conveyance direction 11 of the forklift 10 is captured in the spherical image. However, even if the forklift moves, changes in the position of an image of distant subject are small. For this reason, when a method of determining the amount of movement of an image is adopted, it is likely that the distant subject is determined to be a fixed feature point of the spherical camera 20. In order to handle such an installation position of the spherical camera 20, measurement using three-dimensional positions in a similar manner to the visual SLAM may be adopted.

In the visual SLAM, a self-position and a subject position are simultaneously determined based on a corresponding relation between images of feature points on a stationary subject. The object 30 that is not-yet held by the forklift 10 is stationary with respect to the floor. Accordingly, the three-dimensional position of the feature point on the object 30 can also be measured by the visual SLAM processes.

By contrast, after the object 30 is held by the forklift 10, the object 30 is not stationary on the floor and the object 30 is substantially static with respect to the spherical camera 20. For this reason, the same feature points that used to be valid may be invalid in the measurement using three-dimensional positions. In particular, such feature points are removed as outliers from the objects to be processed in the measurement using three-dimensional positions.

In order to deal with such a situation, feature points are tracked in an image area that includes the object 30, and whether the feature point of interest is stationary with respect to the floor or stationary with respect to the camera can be determined based on whether the feature point is to be processed in the three-dimensional computation.

Through the use of the above result, even when the spherical image does not include the fork 21 or the floor viewable through the space between the two bars of the fork 21, whether the object 30 is being held or not held can be determined to detect the attachment and detachment of the object 30 in a similar manner to the method of determining the amount of movement of an image.

In the arrangement described above, the fork 21 is not included in the spherical image. Accordingly, edges of the fork 21 cannot be detected, and the AR marker cannot be detected to measure the height of the object 30 at the time of its attachment and detachment. For this reason, such a configuration is applicable only to a type of lift that cannot lift the fork 21 to a high position but can only slightly lift up an object from the floor, or for example, an additional sensor that measures the height of a fork needs to be used in combination with the main sensor.

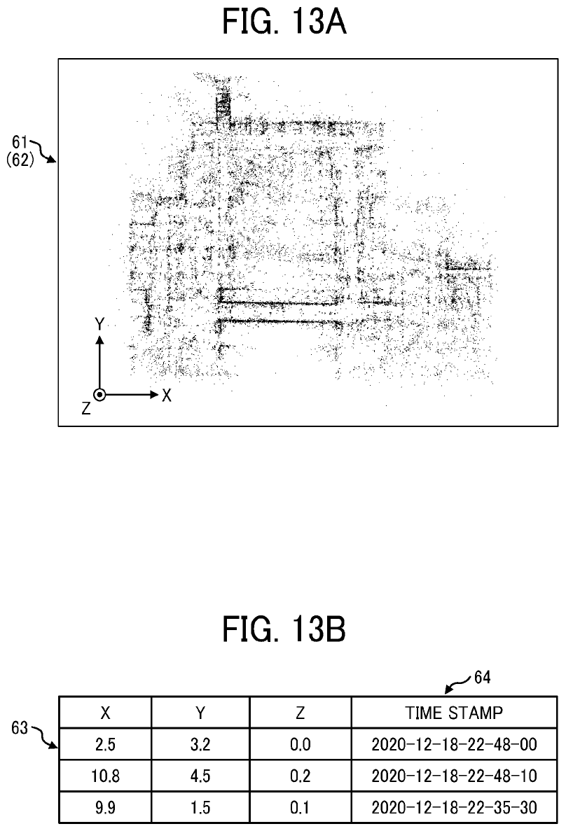

FIG. 13A and FIG. 13B are diagrams each illustrating a first result of obtaining the information of the positions of the objects 30, according to an embodiment of the present disclosure.

FIG. 13A illustrates a location map 61 according to the present embodiment. FIG. 13B is a table indicating the information about the positions of the objects 30 and time stamps, according to the present embodiment.

The location map 61 as illustrated in FIG. 13A is generated by the mobile-object position acquisition unit 52 based on the spherical image captured by the spherical camera 20. The mobile-object position acquisition unit 52 according to the present embodiment obtains a group of points including the three-dimensional coordinate data, and projects the obtained group of points onto a two-dimensional plane. As a result, the location map 61 is generated.

The location map 61 is generated in accordance with, for example, the movement of one of the forklifts 10, and is used to obtain the information about the positions of all the forklifts 10. Such obtainment of the information about the positions of objects may be referred to as localization in the following description. Due to such a configuration, the varying positions of the multiple forklifts 10 can be expressed in the same coordinate system.

As a method of generating the location map 61 based on captured images such as spherical images, for example, simultaneous localization and mapping (SLAM) may be applied (see, for example, “Tomono, M., & Hara, Y. Commentary on Current Status and Future Prospects of SLAM. System/Control/Information, vol. 64, No. 2, pp. 45-50, from https://www.jstage.jst.go.jp/article/isciesci/64/2/64_45/_article/-char/jar). Due to such localization based on captured images, the information about the positions of objects can be obtained with higher accuracy than other methods of obtaining the positions of objects using a global positioning system (GPS) or an acceleration sensor when captured images can be stably obtained as in an indoor environment.

In a cross-docking warehouse where there are few structures such as shelves and the pallets 31 or the cargoes 32 tend to be directly placed on the floor, the location map 61 is likely to change as the positions of the objects 30 change due to the arrival and shipping of the pallets 31. Such changes in the location map 61 may complicate the processes of obtaining the information about the positions of the objects 30.

By contrast, in many cases, the height of the ceiling in a warehouse is as high as, for example, meters (m), and the upper sight on the ceiling side can be obtained with reliability. In view of these circumstances, in the present embodiment, the location map 61 is generated using an image indicating the upward direction of the spherical image captured by the spherical camera 20, and the information about the positions of the forklifts 10 are obtained. Due to such a configuration, without complicating the processes, the information about the positions of the forklifts 10 can be obtained using the location map 61 in which the temporal change is controlled.

The holding-information acquisition unit 53 according to the present embodiment uses a front portion of the spherical image in order to obtain the holding information of the objects 30 by the forklift 10. Due to such a configuration, the information about the positions of the forklifts and the holding information of the objects 30 can be obtained using one of the spherical images captured by the spherical camera 20.

The holding-information acquisition unit 53 may also use information other than the spherical image in order to obtain the holding information. The information other than the spherical image may be, for example, the information detected by a contact sensor, an infrared sensor, an ultrasonic sensor, a range finder, and a load sensor. The holding-information acquisition unit may obtain the holding information using the spherical image and the information detected by each sensor in combination. However, from the viewpoint of simplifying the processes, it is more preferable to use the spherical camera 20 that can obtain the information about the positions of the forklifts 10 and the holding information of the forklifts 10 from a single spherical image.

The object position acquisition unit 56 according to the present embodiment uses a position at which the holding information has changed from a held state to a not-held state in the information about the positions of the forklifts 10 indicated on the location map 61. By so doing, the location map 62 that indicates the positions of the objects 30 can be obtained. The location map 61 as illustrated in FIG. 13A may be said to indicate the information about the positions of the object 30. For this reason, the location map 62 is indicated in FIG. 13A in parentheses.

A position table 63 as illustrated in FIG. 13B is a table including the three-dimensional coordinates of a point group indicating the positions of the objects 30 and a time stamp 64 indicating the times at which the three-dimensional coordinates are obtained. The position table 63 is generated by the object position acquisition unit 56. The time stamp 64 according to the present embodiment serves as time information obtained by the time acquisition unit 55. The object position acquisition unit 56 according to the present embodiment can output the position table 63 in which the information about the position of the objects 30 and the time information are associated with each other through the output unit 57.

The object position acquisition unit 56 excludes the information of a point group after a predetermined length of time has passed, and updates the position table 63 using the information of a new point group. Accordingly, even when it is difficult to secure an upper sight and it is necessary to rely on the sight in the horizontal direction, the information about the positions of the forklift 10 and the information about the positions of the objects 30 can be obtained as desired in response to a change in the surroundings of the forklift 10. However, when the movement of the forklift 10 is small, the number of newly obtained point groups is small. In such cases, the number of points may decrease. In order to handle such a situation, the frequency of updating the position table 63 may be reduced when the amount of movement is small in accordance with the amount of movement of the forklift 10. By so doing, the information of the point group depicted in the position table 63 can be prevented from decreasing excessively.

Identification data such as a bar code applied to the objects 30 is used to track the varying positions of the multiple objects 30 within the warehouse 100. The data identifying the object 30 is stored in the storage unit 58 together with the information about the initial position of the object 30.

As the identification data indicating the object 30, when the forklift 10 picks up the pallet 31 from the container 300 or the like and places the pallet 31 on a temporary basis, the information obtained by reading a bar code or the like given to the cargo 32 or the pallet 31 is stored in the storage unit 58. Such a storage operation is referred to as initial registration. In the present embodiment, in addition to the identification data indicating the object 30 to be initially registered, the information about the positions of the objects 30 obtained by the object position acquisition unit 56 can be stored in the storage unit 58 in association with each other.

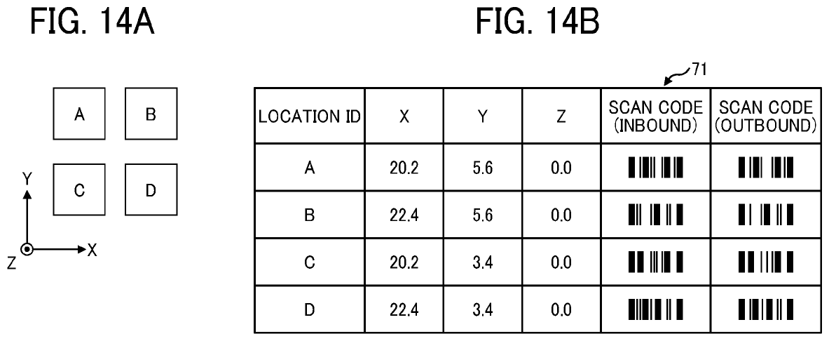

A simple method for tracking the varying positions of the multiple objects 30 in the warehouse 100, according to the present embodiment, is described below with reference to FIG. 14A and FIG. 14B.

FIG. 14A and FIG. 14B are diagrams each illustrating a second result of obtaining the information of the positions of the objects 30, according to the present embodiment.

FIG. 14A is a diagram illustrating divisions A, B, C, and D according to the present embodiment. FIG. 14B is a diagram illustrating the information about the positions of divisions A, B, C, and D and bar codes indicating the divisions A, B, C, and D, according to the present embodiment.

The divisions A, B, C, and D as illustrated in FIG. 14A indicate the predetermined position ranges of in the warehouse 100. Each one of the objects 30 is initially registered to one of the divisions A, B, C and D.

The bar codes indicating the divisions A, B, C, and D are scanned at any one of timings before and after the bar code indicating the object 30 is read using a reader. By so doing, the objects can be associated with the coordinates of the multiple divisions A, B, C, and D. After that, the position of the object 30 can be tracked with the identification data indicating which one of the objects 30 is being carried when the object 30 is carried by the forklift 10. In a table 71 as illustrated in FIG. 14B, identification (ID) numbers indicating the divisions (A, B, C, and D), the information about the positions of the divisions (A, B, C, and D), and the bar codes indicating the divisions (A, B, C, and D) are associated with each other.

Each of the bar codes that indicates one of the divisions A, B, C, and D is printed and carried by an operator such that the operator who does the initial registration can scan the bar code using a reader. Alternatively, the bar codes that indicate the divisions A, B, C, and D may be pasted on to the floor or a column in the warehouse 100, or on the forklift 10. Due to such a configuration, the bar code that indicates one of the multiple divisions A, B, C, and D can be easily read before or after the bar code that indicates the object 30 is scanned.

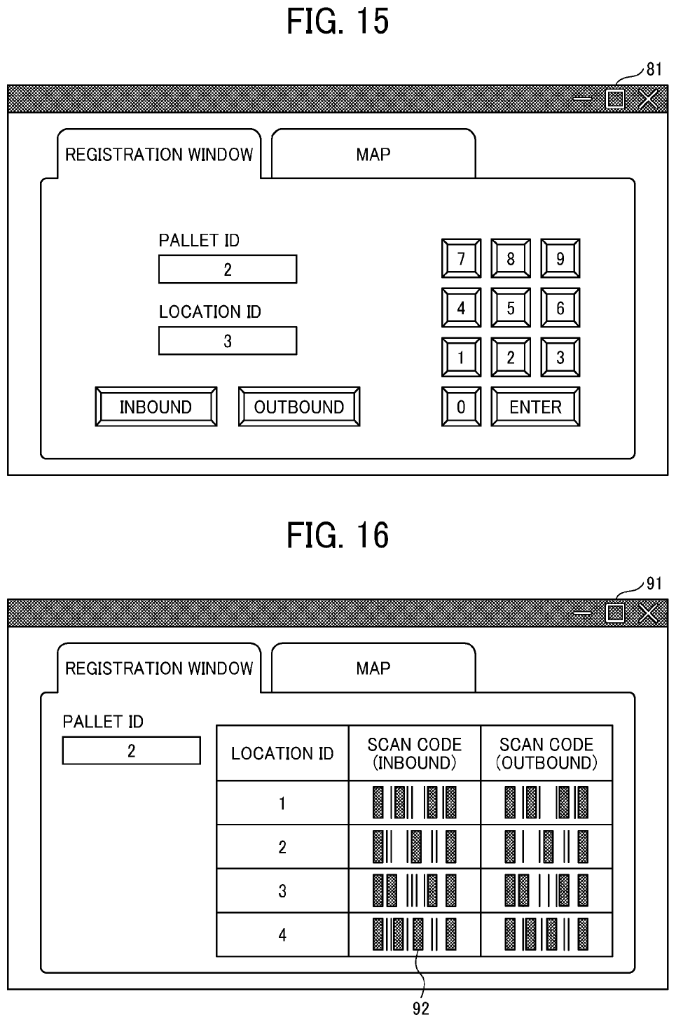

FIG. 15 is a diagram illustrating a registration screen 81 on which an initial position of the object 30 is registered, according to the present embodiment.

For example, a mobile device that reads a bar code indicating the object 30 is mounted on the forklift 10, and an operator performs a registration operation using the mobile device. A registration screen 81 illustrated in FIG. 15 is a screen displayed by the mobile device. The information that is read using a simple method as illustrated in FIG. 14A and FIG. 14B may be displayed on a mobile device to allow an operator to select information indicating the arrival or shipment of the cargo 32, or to confirm the ID numbers of the objects 30 and the divisions A, B, C, and D.

FIG. 16 is a diagram illustrating a registration screen 91 on which an initial position of the object 30 is registered, according to an alternative embodiment of the present disclosure.

The registration screen 91 as illustrated in FIG. 16 is a display screen of a mobile device, and each bar code 92 indicates one of the divisions A, B, C, and D. The initial position can be registered by displaying, on the registration screen 91, a bar code indicating whether the cargo is arrived or to be shipped or a division (A, B, C, and D) that is a candidate for the initial position, and by reading a suitable bar code from the displayed bar code using a reader by an operator.

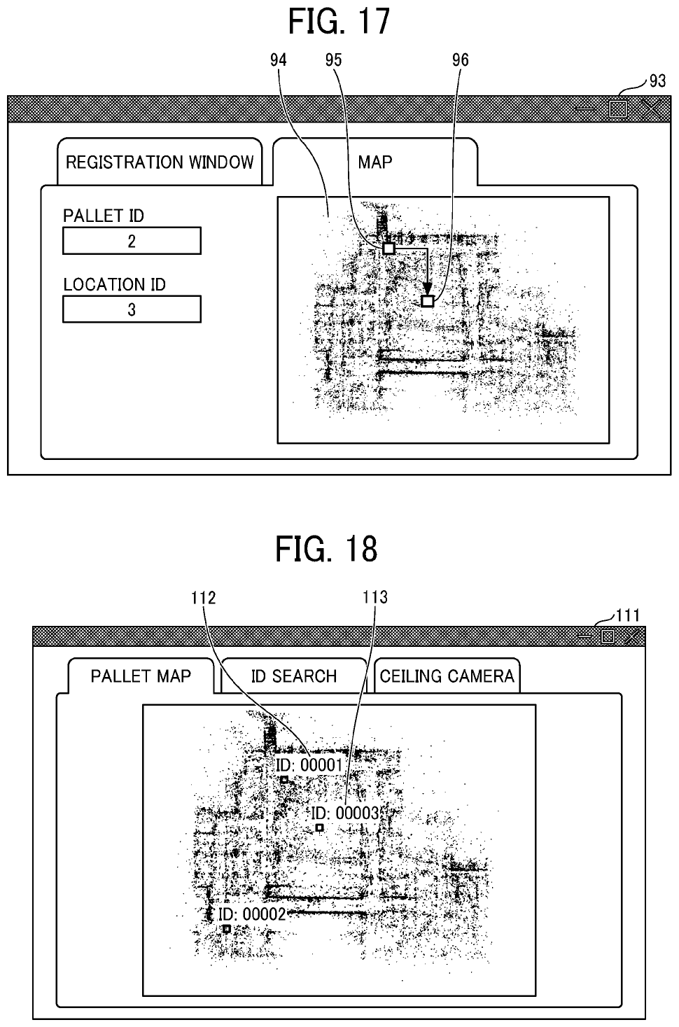

FIG. 17 is a diagram illustrating a display screen 93 indicating a destination to which the object is carried by the forklift 10, according to the present embodiment.

The display screen 93 according to the present embodiment displays a location map 94. The location map 94 includes an original position 95 and a destination 96. The original position indicates a position from which an object is carried, and
the destination 96 indicates a position to which the object is carried. By displaying the position of, for example, a predetermined temporary receptacle on the screen, information that can easily be handled can be provided.

FIG. 18 is a diagram illustrating a display screen 111 on which a location map is displayed, where the location map indicates the locations of the multiple objects 30, according to the present embodiment.

The display screen 111 may be a screen displayed on a mobile device arranged at the forklift 10, or may be a screen displayed on the display 506 of the on-premises server 50.

The on-premises server 50 displays, for example, the ID number 112 or 113, indicating all the objects 30 on a map, based on the coordinate data of each of the objects 30 during a period from when the object 30 is initially registered in the warehouse 100 to when the bar code is read at the time of shipment.

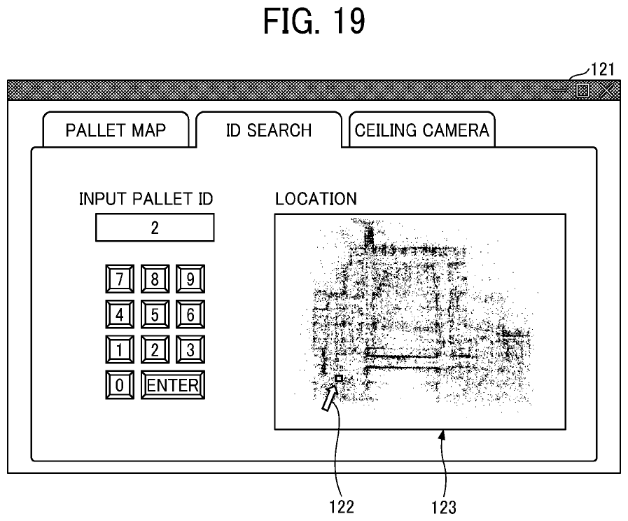

FIG. 19 is a diagram illustrating a screen displayed when the objects 30 are being searched for, according to the present embodiment.

The display screen 121 may be a screen displayed on a mobile device provided in the forklift 10, or may be a screen displayed on the display 506 of the on-premises server 50.

Once an ID number of the pallet 31 to be searched for is input by an operator who is searching for the object 30 to be carried, the display screen 121 displays a mark 122 that indicates the position of the corresponding one of the pallets 31 on the location map 123. In so doing, the number of pallets 31 whose positions are to be displayed is not limited to one, and a plurality of ID numbers of the multiple pallets 31 may be sequentially input such that the varying positions of the multiple pallets 31 will collectively be displayed.

As described above, the on-premises server 50 according to the present embodiment that serves as an information processing device and is included in the information processing system 1 processes the information of the positions of the objects 30 that are moved or carried by the forklift 10 that serves as a mobile object.

The on-premises server 50 outputs the information about the position of the objects 30, which are obtained based on the information about the positions of the forklifts 10, which is obtained based on the spherical images captured by the spherical camera 20 that serves as an imaging device, and the holding information indicating whether each one of the objects 30 is held or not held by any one of the forklifts 10.

In the present embodiment, the information about the positions of the forklift 10 is obtained based on the captured images. Accordingly, the information about the positions can be obtained with a minimum device configuration compared with, for example, a method or configuration in which a plurality of wireless communication tags are installed indoors and a device such as a receiver is attached to a mobile object. Accordingly, the on-premises server 50 can be provided that can easily process the information about the positions of the object 30 carried by the forklift 10.

In the present embodiment, the holding-information acquisition unit 53 obtains holding information based on the obtained spherical image. Due to such a configuration, the holding information and the information about the position of the forklifts 10 can be obtained based on a single spherical image. Accordingly, the information about the positions of the object 30 can be processed in a simplified manner.

In the present embodiment, the spherical image is an image captured by the spherical camera provided for the forklift 10. Accordingly, the capturing range of the spherical camera 20 changes according to the movement of the forklift 10 inside or outside the warehouse 100, and it is possible to capture an image of a wider range inside or outside the warehouse 100.

In the present embodiment, a spherical image includes an image in which the scenery viewed from the forklift 10 in the conveyance direction 11 of the object 30 and the scenery viewed from the forklift 10 in the upper vertical direction 12 are captured. The information about the positions of the forklift 10 can be obtained by simple processes from an image obtained by imaging a scene on the ceiling side of the warehouse where the sight is easily secured. Further, the holding information can be obtained that indicates whether the object 30 is held or not held in the scenery viewed from the forklift 10 in the conveyance direction 11. Due to such a configuration, the varying positions of the multiple objects 30 can precisely be recognized and tracked with a relatively simple configuration or structure of the information processing system 1.

In the present embodiment, the on-premises server 50 includes the receiver 51 that receives at least one of the holding information and the information about the positions of the forklifts 10. The information about the positions of the objects 30 can be obtained using at least one of the received holding information and the information about the positions of the forklifts 10. If the receiver 51 receives these pieces of information by wireless communication, complicated wiring can be omitted. For this reason, the data communication through the wireless communication in the present embodiment is desirable.

In the present embodiment, a time stamp 64 that indicates the time and corresponds to the position of the object 30 is further output. Due to such a configuration, the varying positions of the multiple objects 30 can easily be recognized and tracked.

In the present embodiment, the on-premises server 50 obtains the identification data indicating the objects 30, and outputs the identification data in association with the information about the positions of the objects 30. Due to such a configuration, the varying positions of the multiple objects 30 can easily be recognized and tracked.

### Second Embodiment

An information processing system 1a according to a second embodiment of the present disclosure is described below. In view of the first embodiment of the present disclosure as described above, like reference signs denote like elements, and redundant description may be omitted where appropriate.

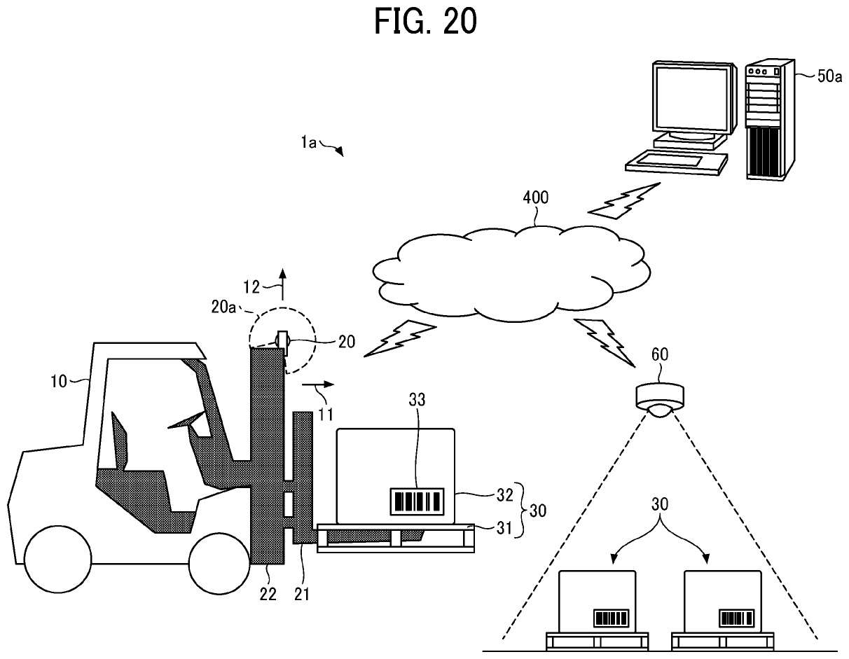

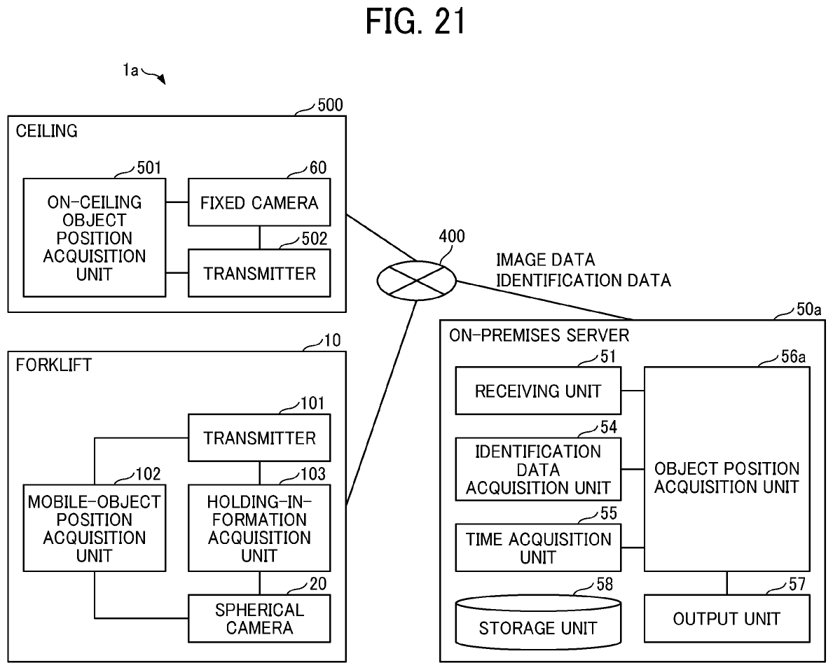

FIG. 20 is a schematic diagram of the information processing system 1a according to the second embodiment of the present disclosure.

As illustrated in FIG. 20, the information processing system 1a includes a fixed camera 60 and an on-premises server 50a.

In addition to the forklift 10, a pallet carrying machine called a pallet jack or pallet truck that can be easily handled by a person may be used in warehouses. In the present embodiment, even when the positions of the objects 30 are changed by a pallet jack with which the spherical camera 20 is not provided, the positions of the objects 30 can be recognized and tracked based on the images captured by the fixed camera 60.

The fixed camera 60 is arranged near the ceiling or the like of the warehouse 100, and captures an image inside the warehouse 100 from the ceiling side toward the floor side. The type of camera of the fixed camera 60 is not particularly limited, but a fixed camera that can capture an image over a wide range is preferable, and a semi-spherical camera such as a fish-eye camera having an angle of view of about 180 degrees is preferred. The fixed camera 60 to be installed may be a single camera or a plurality of cameras. In the present embodiment, it is assumed that a plurality of fixed cameras 60 are arranged, and the multiple fixed cameras 60 may collectively be referred to as the fixed camera 60.

FIG. 21 is a block diagram of a functional configuration of the information processing system 1a according to the second embodiment of the present disclosure.

As illustrated in FIG. 21, the fixed camera 60, an on-ceiling object position acquisition unit 501, and the transmitter 502 are arranged on the ceiling 500.

The multiple functions of the on-ceiling object position acquisition unit 501 and the transmitter may be implemented by an electric circuit provided for one of the ceiling 500 and the fixed camera 60, or may be implemented by software executed by a central processing unit (CPU). Alternatively, these functions of the on-ceiling object position acquisition unit 501 and the transmitter 502 may be implemented by a plurality of electric circuits or a plurality of software components.

The fixed camera 60 according to the present embodiment serves as a second imaging device that is not arranged on the forklift 10 but is arranged on other places or devices to capture an image around either one of the forklift 10 and the object 30. The image that is captured by the fixed camera 60 is an example of a second captured image.

The on-ceiling object position acquisition unit 501 according to the present embodiment obtains the information about the positions of the objects 30 conveyed by means other than the forklift 10, based on the images captured by the fixed camera 60, and sends the information about the position of the objects to the on-premises server 50a through the transmitter 502. The information about the positions of the objects 30 that is obtained by the on-ceiling object position acquisition unit 501 based on the images captured by the fixed camera 60 is an example of the second position information.

The forklift 10 is provided with a mobile-object position acquisition unit 102 and a holding-information acquisition unit 103. The forklift 10 includes a single board computer, and is connected to the spherical camera 20 through a wired connection. The functions of the mobile-object position acquisition unit 102 and the holding-information acquisition unit 103 are implemented by such a single-board computer.

The spherical camera 20 according to the present embodiment serves as a first imaging device provided for the forklift 10. The spherical image (omnidirectional image) that is captured by the spherical camera 20 according to the present embodiment is an example of first captured image.

The mobile-object position acquisition unit 102 according to the present embodiment obtains the information about the positions of the forklifts 10 based on the images captured by the spherical camera 20, and transmits the information of the positions of the forklifts 10 to the on-premises server 50a through the transmitter 101.

Based on the images captured by the spherical camera 20, the holding-information acquisition unit 103 according to the present embodiment obtains the holding information indicating whether the object 30 is being held or not held by the forklift 10, and transmits the obtained holding information to the on-premises server 50a through the transmitter 101.

The on-premises server 50a according to the present embodiment includes an object position acquisition unit 56a. The object position acquisition unit 56a according to the present embodiment obtains the information of the positions of the objects 30 carried by the forklifts based on the information about the positions of the forklifts 10 and the holding information of the objects 30, which are received through the receiver 51. The information about the positions of the objects 30, which is obtained based on the spherical image captured by the spherical camera 20 is an example of first position information.

Moreover, the object position acquisition unit 56a according to the present embodiment can obtain the information about the positions of the objects 30 carried by a mobile object other than the forklift 10 through the receiver 51. The information about the positions of the objects 30, which is obtained based on the images captured by the fixed camera 60 is an example of second position information. The object position acquisition unit 56a can output the obtained information about the positions of the objects 30 through the output unit 57.

In order to recognize and track the positions of the objects 30, it is desired that the three-dimensional coordinate system be matched between the position of the fixed camera 60 and the positions of the objects 30. In order to achieve such matching of three-dimensional coordinate system, a marker whose three-dimensional coordinate data is known is pasted onto the floor of the warehouse 100 and the marker is recognized by the fixed camera 60. The three-dimensional coordinate system may be matched by initially registering the position of the fixed camera 60 using the three-dimensional coordinate data of the forklift 10 whose position is already recognized.

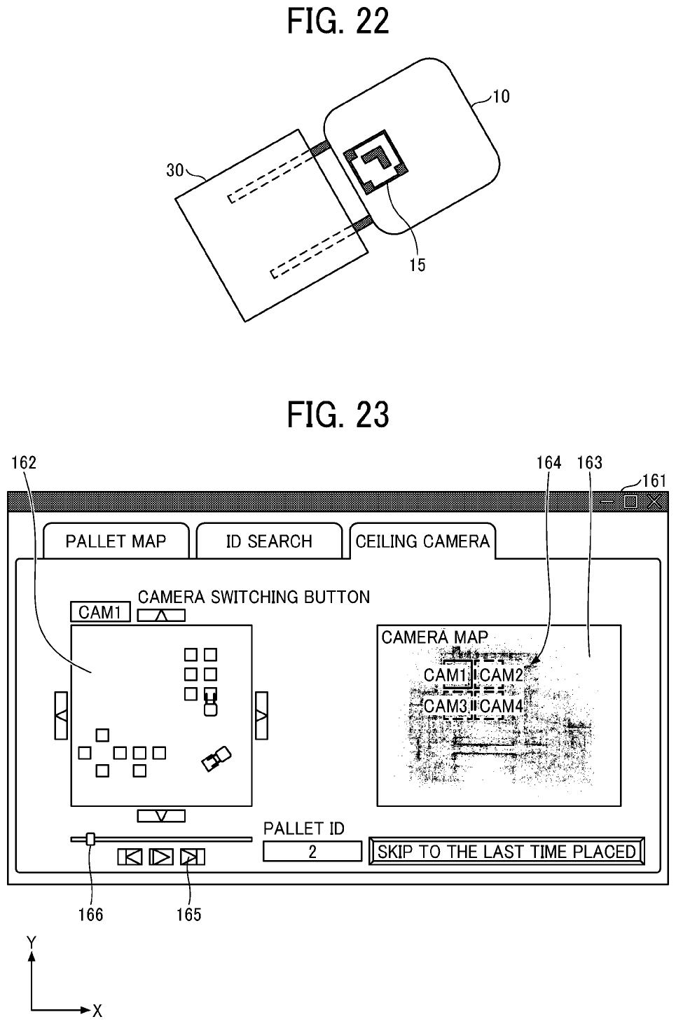

FIG. 22 is a diagram illustrating the forklift 10 as viewed from the fixed camera 60, according to an embodiment of the present disclosure.

As illustrated in FIG. 22, the forklift 10 is provided with an identification marker 15. Preferably, the identification marker 15 is a two-dimensional code that can easily be recognized from the ceiling 500. The fixed camera 60 recognizes the identification marker 15 to initially register the position of the fixed camera 60. By so doing, the three-dimensional coordinate system can be calibrated.

FIG. 23 is a diagram illustrating a display screen 161 displaying the result of tracking performed on the objects 30 by the fixed camera 60, according to the present embodiment.

The display screen 161 may be a screen displayed on a mobile device arranged at the forklift 10, or may be a screen displayed on the display 506 of the on-premises server 50.

As illustrated in FIG. 23, the display screen 161 includes a captured-image screen 162 and a camera location map screen 163. The captured-image screen 162 displays the images captured by the fixed camera 60, and can display not only still images but also moving images. The positions of the multiple fixed cameras 60 are indicated on the camera location map screen 163. The camera location map screen 163 includes a plurality of camera marks 164, and those camera marks 164 indicate the positions of those fixed cameras 60.

The captured-image screen 162 according to the present embodiment can be scrolled in either one of the X-direction and the Y-direction indicated by arrows in FIG. 23. An operator who carries the object 30 can select one of the multiple fixed camera 60 whose captured images are desired to be displayed while viewing the camera location map screen 163.

In FIG. 23, a fast-forward key 165 and a scroll bar 166 are illustrated. A function to keep track of the location may be provided. With such a function, the reproduction of the moving images can be jumped to the time when the object 30 of particular ID number to be searched for is lastly placed at a particular location. Due to such a function to keep track of the location, even when the object 30 is moved afterward by something other than the forklift 10, the reproduction for tracking can be efficiently performed.

As described above, the information processing system 1a according to the present embodiment includes the fixed camera 60. Due to such a configuration, even when the positions of the objects 30 are changed by a pallet jack with which the spherical camera 20 is not provided, the positions of the objects 30 can be recognized and tracked based on the images captured by the fixed camera 60.

### Modification

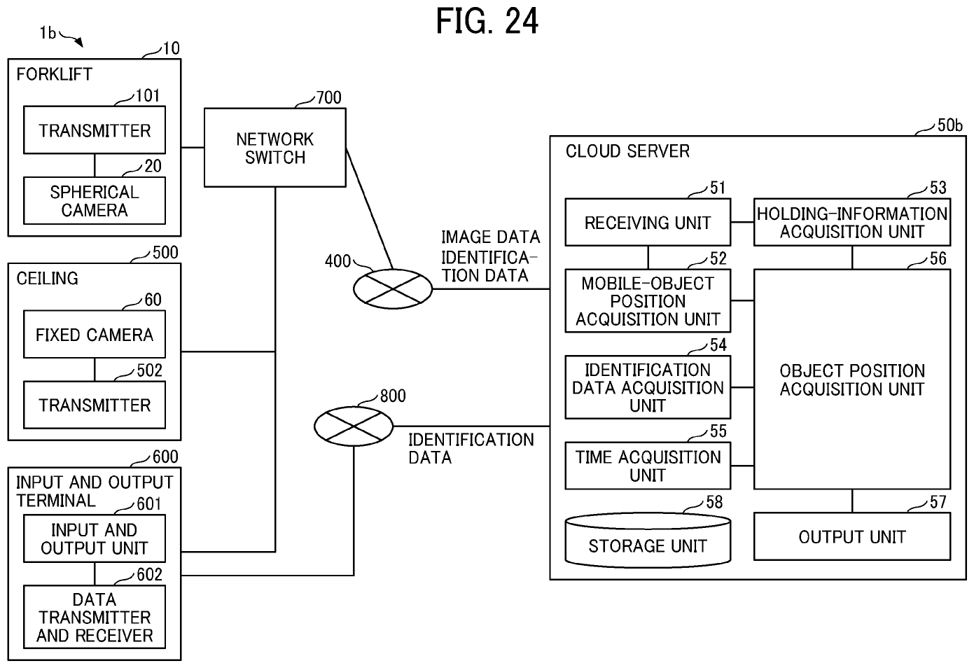

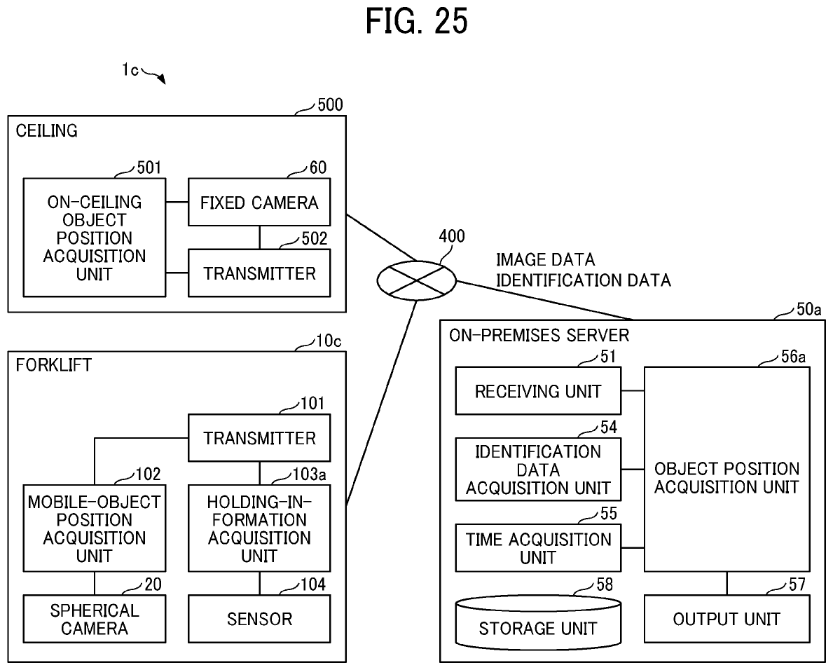

FIG. 24 is a block diagram illustrating a functional configuration of an information processing system 1b according to a first modification of the above embodiments of the present disclosure.

As illustrated in FIG. 24, the information processing system 1b includes a cloud server 50b, an input and output terminal 600, and a network switch 700. The input and output terminal 600 and the cloud server 50b are connected to each other and can communicate with each other through the Internet 800.

The cloud server 50b is an external server installed outside the warehouse 100. The cloud server 50b has a hardware configuration similar to that of the on-premises server 50 illustrated in FIG. 3.

The input and output terminal 600 includes an input and output unit 601 and a data transmitter and receiver 602. For example, the input and output terminal 600 is a mobile device mounted on the forklift 10 as described above in the first embodiment of the present disclosure. The network switch 700 is a switch capable of switching between the network 400 and the Internet 800.

The information processing system according to the above embodiments of the present disclosure may be configured as illustrated in FIG. 24.

FIG. 25 is a block diagram illustrating a functional configuration of an information processing system 1c according to a second modification of the above embodiments of the present disclosure.

As illustrated in FIG. 25, the information processing system 1c includes a forklift 10c. The forklift 10c according to the present modification of the above embodiments of the present disclosure includes a sensor 104 and a holding-information acquisition unit 103b.

The sensor 104 may be, for example, at least one of a contact sensor, an infrared sensor, an ultrasonic sensor, a range finder, and a load sensor. The sensor 104 detects data or a signal used to obtain holding information.

The holding-information acquisition unit 103b can obtain holding information based on the data or signals detected by the sensor 104.

The information processing system according to the above embodiments of the present disclosure may be configured as illustrated in FIG. 25.

Numerous additional modifications and variations are possible in light of the above teachings. It is therefore to be understood that within the scope of the appended claims, the embodiments of the present disclosure may be practiced otherwise than as specifically described herein. For example, elements and/or features of different illustrative embodiments may be combined with each other and/or substituted for each other within the scope of this disclosure and appended claims.

The forklift according to the above embodiments of the present disclosure serves as a mobile object. However, no limitation is intended thereby. For example, the mobile object may be an automatically-carrying vehicle or a drone.

Embodiments of the present disclosure includes an information processing method. For example, such an information processing method is a method of processing information using an information processing apparatus that processes information about a position of an object moved by a mobile object, and the method includes a step of outputting the information about the position of the object, the information about the position of the object being obtained based on holding information indicating whether the object is held or not held by the mobile object and information about a position of the mobile object, the information about the position of the mobile object being obtained based on a captured image captured by an imaging device. With such a method of detecting objects, functions or effects similar to those implemented by the above information processing system can be implemented.

Embodiments of the present disclosure includes a non-transitory computer-readable recording medium storing a program for causing a computer to execute a method. For example, such a program is executed by an information processing apparatus that processes information about a position of an object moved by a mobile object, and the program causes a computer to execute a method including a step of outputting the information about the position of the object, the information about the position of the object being obtained based on holding information indicating whether the object is held or not held by the mobile object and information about a position of the mobile object, the information about the position of the mobile object being obtained based on a captured image captured by an imaging device. With such a program, functions or effects similar to those implemented by the above information processing system can be implemented.

The numbers such as ordinal numbers and numerals that indicates quantity are all given by way of example to describe the technologies to implement the embodiments of the present disclosure, and no limitation is indicated to the numbers given in the above description. The description as to how the elements are related to each other, coupled to each other, or connected to each other are given by way of example to describe the technologies to implement the embodiments of the present disclosure, and how the elements are related to each other, coupled to each other, or connected to each other to implement the functionality in the present disclosure is not limited thereby.

The division of blocks in the functional block diagrams is given by way of example. A plurality of blocks may be implemented as one block, or one block may be divided into a plurality of blocks. Alternatively, some functions may be moved to other blocks. The functions of a plurality of blocks that have similar functions may be processed in parallel or in a time-division manner by a single unit of hardware or software. Some or all of the functions according to the above embodiments of the present disclosure may be distributed to a plurality of computers.

The present invention can be implemented in any convenient form, for example using dedicated hardware, or a mixture of dedicated hardware and software. The present invention may be implemented as computer software implemented by one or more networked processing apparatuses. The processing apparatuses include any suitably programmed apparatuses such as a general purpose computer, a personal digital assistant, a Wireless Application Protocol (WAP) or third-generation (3G)-compliant mobile telephone, and so on. Since the present invention can be implemented as software, each and every aspect of the present invention thus encompasses computer software implementable on a programmable device. The computer software can be provided to the programmable device using any conventional carrier medium (carrier means). The carrier medium includes a transient carrier medium such as an electrical, optical, microwave, acoustic or radio frequency signal carrying the computer code. An example of such a transient medium is a Transmission Control Protocol/Internet Protocol (TCP/IP) signal carrying computer code over an IP network, such as the Internet. The carrier medium also includes a storage medium for storing processor readable code such as a floppy disk, a hard disk, a compact disc read-only memory (CD-ROM), a magnetic tape device, or a solid state memory device.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), a digital signal processor (DSP), a field programmable gate array (FPGA), and conventional circuit components arranged to perform the recited functions.

This patent application is based on and claims priority to Japanese Patent Application Nos. 2021-028975 and 2021-029222, filed on Feb. 25, 2021, in the Japan Patent Office, the entire disclosure of each of which is hereby incorporated by reference herein.

### REFERENCE SIGNS LIST

1 Information processing system
10 Forklift (example of mobile object)
11 Conveyance direction (example of moving direction)
12 Upper vertical direction
15 AR marker (example of identification marker)
20 Spherical camera (example of imaging device and first imaging device)
20a Direction
21 Fork
22 Supporting member
30 Object
31 Pallet
32 Cargo
33 Barcode (example of identification data)
40 Temporary receptacle
50 On-premises server (example of information processing apparatus)
50b Cloud server (example of information processing apparatus)
51 Receiver
52 Mobile-object position acquisition unit
53 Holding-information acquisition unit
54 Identification data acquisition unit
55 Time acquisition unit
56 Object position acquisition unit
57 Output unit
58 Storage unit
60 Fixed camera (example of second imaging device)
61 Location map (example of information about position of mobile object)
62 Location map(example of information about position of object)
63 Position table (example of information about position of object)
64 Time stamp (example of time information)
81, 91 Registration screen
100 Warehouse
200 Truck yard
266 Perspective transformed image
267 Fork image
272 AR marker image
300 Container
313 Monitoring area
314 Multiple monitoring areas
400 Network
H Height

1. An information processing apparatus, comprising:
output circuitry configured to output information about a position of an object, the information about the position of the object being obtained based on holding information indicating whether the object is held or not held by a mobile object and information about a position of the mobile object, the information about a position of the mobile object being obtained based on a captured image captured by an imaging device.

2. The information processing apparatus according to claim 1, further comprising:
holding-information acquisition circuitry configured to obtain the holding information based on the captured image.

3. The information processing apparatus according to claim 1, further comprising:
an object position acquisition circuitry configured to obtain the information about the position of the object based on the information about the position of the mobile object and the holding information.

4. The information processing apparatus according to claim 1, wherein:
the captured image is an image captured by the imaging device attached to the mobile object.

5. The information processing apparatus according to claim 1, wherein:
the captured image includes an image in which scenery viewed from the mobile object in a moving direction of the object and scenery viewed from the mobile object in an upper vertical direction are captured.

6. The information processing apparatus according to claim 1, wherein:
the captured image includes a first captured image captured by a first imaging device attached to the mobile object and a second captured image captured by a second imaging device disposed at a place other than the mobile object and configured to capture an image of an area around at least one of the mobile object and the object.

7. The information processing apparatus according to claim 6, wherein the information about the position of the object includes:
first data of a position of the object obtained based on the first captured image and
second data of a position of the object obtained based on the second captured image.

8. The information processing apparatus according to claim 7, further comprising:
a holding-information acquisition circuitry configured to obtain the holding information based on the captured image,
wherein the captured image includes an image of a holder, and
wherein the image of the holder is captured by the imaging device attached to the mobile object.

9. The information processing apparatus according to claim 8, wherein:
the captured image includes the image of the holder and also an image of a floor on which the mobile object moves, and
the holding-information acquisition circuitry is configured to obtain the holding information based on an amount of movement of the floor or the object in a monitoring area included in the captured image and an amount of movement of the mobile object obtained based on the information about the position of the mobile object.

10. The information processing apparatus according to claim 8, wherein:
the captured image includes an identification marker indicating the holder, and
the holding-information acquisition circuitry is configured to obtain the holding information based on the identification marker.

11. The information processing apparatus according to claim 10, wherein:
the holding-information acquisition circuitry is configured to correct the information about the position of the object based on the identification marker.

12. The information processing apparatus according to claim 8, wherein:
the holding-information acquisition circuitry is configured to detect a height of the holder based on the captured image, and
the output circuitry is configured to output the information about the position of the object obtained based on the height of the holder, the holding information, and the information about the position of the mobile object.

13. The information processing apparatus according to claim 8, wherein:
the captured image includes an image of the holder and an image of scenery viewed from the mobile object in a moving direction of the mobile object, and the image of the scenery is captured by the imaging device attached to the mobile object.

14. The information processing apparatus according to claim 1, further comprising:
a receiver to receive at least one of the holding information and the information about the position of the mobile object.

15. The information processing apparatus according to claim 1, wherein:
the output circuitry is configured to further output data indicating a time and corresponding to the position of the object.

16. The information processing apparatus according to claim 1, further comprising:
an identification data acquisition circuitry configured to obtain identification data indicating the object,
wherein the output circuitry is configured to further output the identification data associated with the information about the position of the object.

17. An information processing system comprising:
the information processing apparatus according to claim 1;
the mobile object; and
the imaging device.

18. The information processing system according to claim 17, wherein:
the imaging device is a spherical camera to capture an image of an area around the mobile object.

19. A method of processing information, comprising:
outputting the information about a position of an object, the information about the position of the object being obtained based on holding information indicating whether the object is held or not held by a mobile object and information about a position of the mobile object, the information about the position of the mobile object being obtained based on a captured image captured by an imaging device.

20. A non-transitory computer-readable recording medium storing a program for causing a computer to execute a method of processing information using an information processing apparatus that processes information about a position of an object moved by a mobile object, the method comprising
outputting the information about the position of the object, the information about the position of the object being obtained based on holding information indicating whether the object is held or not held by the mobile object and information about a position of the mobile object, the information about the position of the mobile object being obtained based on a captured image captured by an imaging device.
